(19) United States
(12) Patent Application Publication
(10) Pub. No.: US 2024/0336724 A1
(43) Pub. Date: Oct. 10, 2024

(54) Reversible Epoxy Polymer with Dynamic Boronic Bond

(71) Applicant: ExxonMobil Technology and Engineering Company, Baytown, TX (US)

(72) Inventors: Ya Xian Wang, Shanghai (CN); Ke Ran Chen, Shanghai (CN); Lulin Xie, Zheijang (CN); Tao Xie, Zheijang (CN); Saifudin M. Abubakar, Swiss, Bukit Timah (SG); Ning Zheng, Zhejiang (CN); Wenxi Gao, Shanghai (CN); Qian Zhaoi, Zhejiang (CN); Yihan Cao, Shanghai (CN)

(21) Appl. No.: 18/681,423

(22) PCT Filed: Jul. 21, 2022
(86) PCT No.: PCT/US22/37828

§ 371 Date: Feb. 5, 2024

Related U.S. Application Data
(60) Provisional application No. 63/229,695, filed on Aug. 5, 2021.

(51) Int. Cl. C08G 59/40; C07F 5/04; C08G 59/24

(52) U.S. Cl. CPC C08G 59/4078; C07F 5/04; C08G 59/245

(57) ABSTRACT

A reversible epoxy polymer obtainable by the reaction between at least one epoxy compound and at least one curing agent, wherein at least part of the epoxy compound contains one reversible borate moiety or derivative thereof per molecule; and/or at least part of the curing agent contains one reversible borate moiety or derivative thereof per molecule; and/or the reaction system further comprises at least one compound containing hydroxyl and epoxy group and at least one BQH-containing compound or its ester derivative, wherein said BQH-containing compound contains two or more B-QH moieties, and wherein the derivative of borate moiety represents a moiety with the oxygen in the borate moiety being replaced with other element of the sixth main group and wherein each Q is independently an element of the sixth main group.

### CROSS REFERENCE TO RELATED APPLICATIONS

This application claims the benefit of and priority to U.S. Provisional Application No. 63/229,695 filed Aug. 5, 2021, the disclosure of which is incorporated herein by reference.

### FIELD OF THE INVENTION

This disclosure relates generally to a reversible epoxy polymer with dynamic boronic bond, to a process for preparing the reversible epoxy polymer, to a composite material comprising a substrate and the reversible epoxy polymer and to a composition comprising the reversible epoxy polymer and to a method for producing the curing agent containing one reversible borate moiety.

### BACKGROUND OF THE INVENTION

Epoxy polymer and its composite materials have lots of advantages including excellent bonding, corrosion resistance, electrical insulation, high strength, light weight and other properties. It is widely used in electrical, mechanical manufacturing, chemical corrosion protection, aerospace, ship transportation and many other industrial fields.

However, epoxy polymer is a typical thermosetting material with permanent cross-linked network, thus insoluble, thawless, and unable to be recycled after curing. Usually, waste epoxy polymer is buried or incinerated, which causes serious waste of resources and environmental pollution.

Therefore, the development of an epoxy polymer that can be recycled and reprocessed has become a very important issue.

### SUMMARY OF THE INVENTION

In a first general aspect, this disclosure provides a reversible epoxy polymer obtainable by the reaction between at least one epoxy compound and at least one curing agent, wherein at least part of the epoxy compound contains one reversible borate moiety or derivative thereof per molecule, wherein the derivative of borate moiety represents a moiety with the oxygen in the borate moiety being replaced with other element of the sixth main group; and/or at least part of the curing agent contains one reversible borate moiety or derivative thereof per molecule, wherein the derivative of borate moiety represents a moiety with the oxygen in the borate moiety being replaced with other element of the sixth main group; and/or the reaction system further comprises at least one compound containing hydroxyl and epoxy group and at least one BQH-containing compound or its ester derivative, wherein said BQH-containing compound contains two or more B-QH moieties, and wherein each Q is independently an element of the sixth main group.

In a second general aspect, this disclosure provides a process for preparing the reversible epoxy polymer according to the present invention, which comprises reacting at least one epoxy compound and at least one curing agent, wherein at least part of the epoxy compound contains one reversible borate moiety or derivative thereof per molecule, wherein the derivative of borate moiety represents a moiety with the oxygen in the borate moiety being replaced with other element of the sixth main group; and/or at least part of the curing agent contains one reversible borate moiety or derivative thereof per molecule, wherein the derivative of borate moiety represents a moiety with the oxygen in the borate moiety being replaced with other element of the sixth main group; and/or the reaction system further comprises at least one compound containing hydroxyl and epoxy group and at least one BQH-containing compound or its ester derivative, wherein said BQH-containing compound contains two or more B-QH moieties and wherein each Q is independently an element of the sixth main group.

In a third general aspect, this disclosure provides a composite material comprising a substrate and the reversible epoxy polymer according to the present invention.

In a fourth general aspect, this disclosure provides a composition comprising the reversible epoxy polymer according to the present invention and at least one additive.

In a fifth general aspect, this disclosure provides use of the reversible epoxy polymer and its composites material according to the present invention in adhesive, coating, paints, flooring, glass replacement, polymer additives, metal substrate, structure material, molding, optical material, encapsulation material, packing material, sealing materials, medical material, fiber-reinforced material, or as functional material.

In a sixth general aspect, this disclosure provides a method for producing the curing agent containing one reversible borate moiety or derivative thereof per molecule of the present invention, comprising reacting a compound containing at least one epoxy-reacting group and at least two hydroxyl groups with a compound containing at least one epoxy-reacting group and one B(QH)₂ group or its ester derivative or its anhydride, wherein each Q is independently an element of the sixth main group, preferably O or S.

Certain aspects of the first, second, third, fourth, fifth and sixth general aspects may include one or more of the following features.

In some aspects, the reversible borate moiety or derivative thereof has a structure of Formula (I):

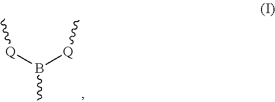

wherein each Q is independently an element of the sixth main group.

In some aspects, the -Q-B-Q- moiety in formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring to form a fused ring system.

In some aspects, the boron-containing ring has the following structure:

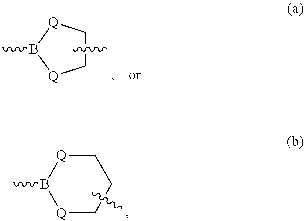

the fused ring system containing the boron-containing ring has the following structure:

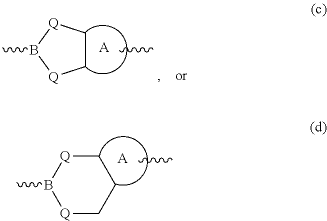

wherein A is a ring having 5 to 10 ring members, and wherein each Q is independently an element of the sixth main group.

In some aspects, wherein the epoxy compound containing one reversible borate moiety or derivative thereof per molecule contains two or more epoxy groups.

In some aspects, epoxy group is selected from ethylene oxide group and oxetane group.

In some aspects, the epoxy compound containing one reversible borate moiety or derivative thereof per molecule is selected from at least one compound having following structure:

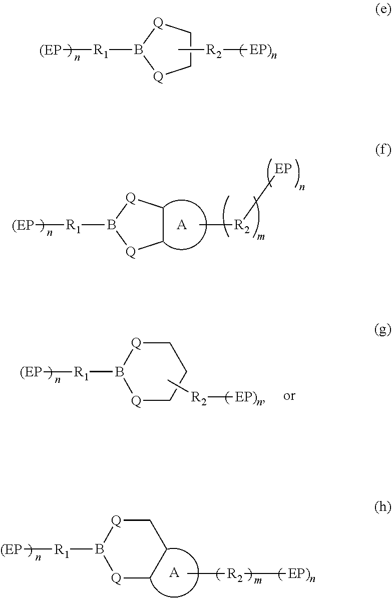

wherein
m is 0 or 1;
each n is independently at least 1;
EP is an ethylene oxide group or oxetane group;
each Q is independently an element of the sixth main group;
each R₁ and R₂ is independently a divalent C₁ to C₂₀ hydrocarbyl; and
wherein A is a ring having 5 to 10 ring members.

In some aspects, each n is independently 1, 2 or 3, and A is a ring having 5 or 6 ring members.

In some aspects, the curing agent containing one reversible borate moiety or derivative thereof per molecule contains two or more functional groups capable of reacting with epoxy group, preferably selected from carboxyl, amino, sulfhydryl or acid anhydride.

In some aspects, the curing agent containing one reversible borate moiety or derivative thereof per molecule is selected from at least one compound having following structure:

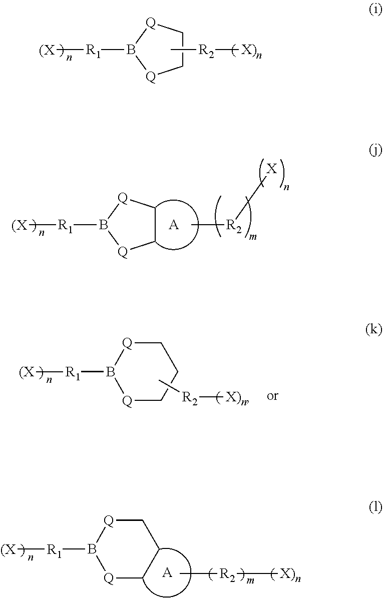

wherein
m is 0 or 1;
each n is independently at least 1, preferably 1, 2 or 3;
each Q is independently an element of the sixth main group;
each R₁ and R₂ is independently a divalent C₁ to C₂₀ hydrocarbyl;
X is a functional group capable of reacting with epoxy group, preferably carboxyl, amino, sulfhydryl or acid anhydride; and
A is a ring having 5 to 10 ring members, preferably a ring having 5 or 6 ring members.

In some aspects, the epoxy compound containing one reversible borate moiety or derivative thereof per molecule is present in an amount of 10 wt % to 100 wt %, preferably 30 wt % to 100 wt % or 30 wt % to 80 wt %, based on the total weight of the epoxy compound.

In some aspects, the curing agent containing one reversible borate moiety or derivative thereof per molecule is present in an amount of 10 wt % to 100 wt %, preferably 30 wt % to 100 wt % or 30 wt % to 80 wt %, based on the total weight of the curing agent.

In some aspects, the BQH-containing compound or its ester derivative is selected from a compound containing at least two B-Q ester bonds, a compound containing at least one B(QH)₂ group, boric acid, and pyroboric acid.

In some aspects, the compound containing at least two B-Q ester bonds comprises a compound containing three B-Q ester bonds, preferably a compound having following structure:

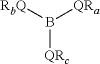

wherein Rₐ, R_{b} and R_{c} are independently hydrocarbyl, preferably alkyl or aryl, and wherein each Q is independently an element of the sixth main group.

In some aspects, the compound containing at least one B(QH)₂ group is selected from benzen-1,4-diboronic acid, 3-carboxyphenylboronic acid, aminobenzeneboronic acid, and tetrahydroxydiboron.

In some aspects, the compound containing hydroxyl and epoxy group has one or two carbon atoms between the hydroxyl and the epoxy group.

In some aspects, the compound containing hydroxyl and epoxy group is glycidol.

In some aspects, the ultimate stress of the reversible epoxy polymer after being reprocessed 3 times at least about 50%, or at least about 65%, preferably at least about 70%, more preferably at least about 72% of the ultimate stress of the reversible epoxy polymer before reprocessing.

In some aspects, the Young's modulus of the reversible epoxy polymer after being reprocessed 3 times at least about 50%, or at least about 65%, preferably at least about 70%, more preferably at least about 75% of the Young's modulus of the reversible epoxy polymer before reprocessing.

In some aspects, the reversible epoxy polymer is obtained by the reaction between at least one epoxy compound and at least one curing agent, wherein at least part of the epoxy compound contains one reversible borate moiety or derivative thereof per molecule and/or at least part of the curing agent contains one reversible borate moiety or derivative thereof per molecule, and wherein at least one of the water absorption rate and the weight loss rate after water soaking of the reversible epoxy polymer is less than 5 wt %, preferably less than 2 wt % after being soaked in water for 24 hours at room temperature.

In some aspects, the content of the insoluble substance is less than 10 wt %, preferably less than 5 wt % after the reversible epoxy polymer being subjected to dissolving in solvent, preferably in a mixture of alcohol with DMF.

In the sixth general aspect, the reaction is carried out in the absence or presence of a dehydrating agent, preferably the dehydrating agent is selected from molecular sieves, Na₂SO₄ and MgSO₄.

In the sixth general aspect, the mole ratio of the compound containing at least one epoxy-reacting group and at least two hydroxyl groups to the compound containing at least one epoxy-reacting group and one B(QH)₂ group or its ester derivative or its anhydride is in the range from 0.5:1 to 2:1, for example from 0.8:1 to 1.2:1.

In the sixth general aspect, the compound containing at least one epoxy-reacting group and at least two hydroxyl groups is selected from 1,2-diol compound containing the at least one epoxy-reacting group and 1,3-diol compound containing the at least one epoxy-reacting group.

In the sixth general aspect, the compound containing at least one epoxy-reacting group and one B(QH)₂ group is 3-aminobenzeneboronic acid or its hydrate or its anhydride and/or the compound containing at least one epoxy-reacting group and at least two hydroxyl groups is select from 1-amino-propane-1,2-diol, N-methylaminopropanediol and N-ethylaminopropanediol.

In the sixth general aspect, the epoxy-reacting group is selected from carboxyl, amino, sulfhydryl or acid anhydride.

In the sixth general aspect, the reaction is carried out in a solvent in which each reagent can be dissolved, preferably the solvent is selected from C₁-C₆ alcohol, THE, dioxane, DMF and mixture thereof.

In the sixth general aspect, the reaction temperature is in the range from 10° C. to the boiling point of the solvent used in the reaction, or from room temperature to the boiling point of the solvent used in the reaction, or from room temperature to 100° C., more preferably from 20° C. to 80° C. or from 20° C. to 65° C.

In the sixth general aspect, the solvent is removed after reaction, preferably the solvent is removed by distillation, for example by spray drying, rotatory evaporator and vacuum dry, more preferably the distillation temperature is no more than 80° C. or no more than 60° C.

In the sixth general aspect, the reaction time is in the range from 4 minutes to 48 hours, or from 0.5 hour to 24 hours.

The reversible epoxy polymer according to the present invention has thermoplastic property and can be recycled and reprocessed and still possesses good mechanical properties after being reprocessed multiple times; the reversible epoxy polymer can also be easily reprocessed via various technical means (such as physical or chemical recycle), possesses excellent self-healing property, water stability, thermal stability and processability; the reversible epoxy polymer can easily form composite material having excellent properties with other material. The method for producing the curing agent containing one reversible borate moiety or derivative thereof per molecule of the present invention is simple, efficient and high-yield synthesis method.

These and other features and attributes of the disclosed reversible epoxy polymer of the present disclosure and their advantageous applications and/or uses will be apparent from the detailed description which follows.

### DESCRIPTION OF THE DRAWING

FIG. 1 (a) shows the samples obtained by hot pressing the reversible epoxy polymer of example 1. FIG. 1 (b) shows the samples obtained by injection molding the reversible epoxy polymer of example 1.

FIG. 2 shows the chemical recycle of the reversible epoxy polymer.

FIG. 3 shows the picture of composite material of the reversible epoxy polymer and carbon fiber obtained in example 5.

FIG. 4 shows DMA curves of reversible epoxy polymer obtained in example 6 and thermoset epoxy polymer.

FIG. 5 shows TGA curves of reversible epoxy polymer obtained in example 6.

FIG. 6 shows viscosity-T curve of reaction product 1 obtained in example 7.

FIG. 7 shows the FTIR spectrum of reaction product 1 obtained in example 7.

FIG. 8 shows the DMA curves of reaction product 2 obtained in example 7.

FIG. 9 shows the FTIR spectrum of reaction product 2 obtained in example 7.

FIG. 10 shows the DMA curves of the reversible epoxy polymer of example 8.

FIG. 11 shows the scratch healing with iron gun.

FIG. 12 shows the scratch repair observed under optical microscopy.

FIG. 13 show the fracture repair.

FIG. 14 shows H¹-NMR of NBN prepared in example 11.

FIG. 15 shows DMA curves of the reversible epoxy polymer of example 11.

FIG. 16 shows DSC curve of the reversible epoxy polymer of example 11.

FIG. 17 shows TGA curve of the reversible epoxy polymer of example 11.

FIG. 18 shows fracture healing under 180° C. for 3 minutes.

FIG. 19 shows ¹H NMR spectra for vials 1-4 in example 15.

FIG. 20 shows the appearance of raw materials from different sources and products thereof.

### DETAILED DESCRIPTION OF THE INVENTION

Various specific embodiments, versions, and examples are described herein; including exemplary embodiments and definitions that are adopted for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

All numerical values within the detailed description and the claims herein are modified by “about” the indicated value, and take into account experimental error and variations that would be expected by those skilled in the art.

In a first general aspect, this disclosure provides a reversible epoxy polymer obtainable by the reaction between at least one epoxy compound and at least one curing agent, wherein at least part of the epoxy compound contains one reversible borate moiety or derivative thereof per molecule, wherein the derivative of borate moiety represents a moiety with the oxygen in the borate moiety being replaced with other element of the sixth main group; and/or at least part of the curing agent contains one reversible borate moiety or derivative thereof per molecule, wherein the derivative of borate moiety represents a moiety with the oxygen in the borate moiety being replaced with other element of the sixth main group; and/or the reaction system further comprises at least one compound containing hydroxyl and epoxy group and at least one BQH-containing compound or its ester derivative, wherein said BQH-containing compound contains two or more B-QH moieties, and wherein each Q is independently an element of the sixth main group.

According to the present invention, the element of the sixth main group is preferably O or S, more preferably O. Q is an element of the sixth main group, preferably O or S, more preferably O.

According to the present invention, the phrase “the oxygen in the borate moiety being replaced with other element of the sixth main group” means the oxygen in the borate moiety is replaced an element of the sixth main group, which is different from oxygen, for example the oxygen in the borate moiety can be replaced with S.

In an embodiment, the derivative of borate moiety represents a moiety with the oxygen in the borate moiety being replaced with S and/or Q is O or S, preferably O.

According to the present invention, there is no substituent on Q.

In one embodiment, the reversible borate moiety or derivative thereof has a structure of Formula (I):

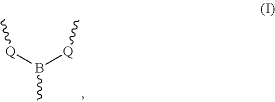

wherein each Q is independently an element of the sixth main group.

In one embodiment, the -Q-B-Q- moiety in formula (I) forms a boron-containing ring having 5 to 8 ring members together with 2 to 5 carbon atoms, preferably forms a boron-containing ring containing 5 or 6 ring members together with 2 or 3 carbon atoms, optionally the boron-containing ring is fused with a further ring to form a fused ring system.

In one embodiment, the boron-containing ring has the following structure:

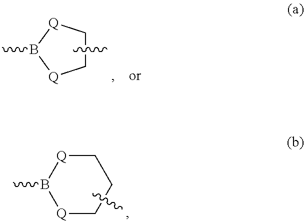

the fused ring system containing the boron-containing ring has the following structure:

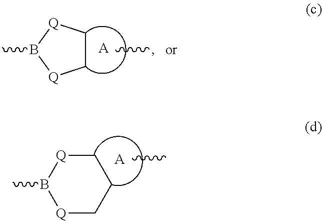

wherein A is a ring having 5 to 10 ring members and wherein each Q is independently an element of the sixth main group.

According to the present invention, the ring (A) fused with the boron-containing ring is a ring having 5 to 10 ring members, such as 5 to 8, or 5, 6, or 7 ring members. The ring (A) is be saturated, or partially unsaturated or aromatic carbo-or heterocyclic ring, which contains 1 to 4 (1, 2, 3, 4) heteroatoms selected from N, O, and S, and wherein the aforementioned carbo-or heterocyclic rings system is unsubstituted or substituted, wherein the substituents on the ring can join to form additional rings.

Examples of the heterocyclic rings as ring (A) include one of following:

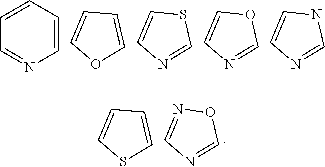

Examples of aromatic ring as ring (A) comprise phenyl ring or naphthalene ring.

In one embodiment, fused ring system containing the boron-containing ring has the following structure:

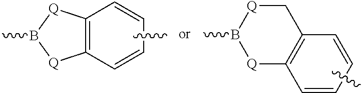

wherein each Q is independently an element of the sixth main group.

### Epoxy Compound

Epoxy compound according to this invention usually have from 2 to 10, preferably from 2 to 6, very particularly preferably from 2 to 4, and in particular 2, epoxy groups. The epoxy group can be selected from ethylene oxide group and oxetane group. The epoxy groups are in particular the glycidyl ether groups that can be produced in the reaction of alcohol groups with epichlorohydrin. The epoxy compound can be low-molecular-weight compounds which generally have an average molar mass (Mn) smaller than 1000 g/mol or relatively high-molecular-weight compounds (polymers). They can be aliphatic or cycloaliphatic compounds, or compounds having aromatic groups. In particular, the epoxy compound are compounds having two aromatic or aliphatic 6-membered rings, or oligomers thereof. Epoxy compounds important in industry are obtainable via reaction of epichlorohydrin with compounds which have at least two reactive hydrogen atoms, in particular with polyols. Particularly important epoxy compounds are those obtainable via reaction of epichlorohydrin with compounds comprising at least two, preferably two, hydroxy groups and comprising two aromatic or aliphatic 6-membered rings.

In one embodiment, at least part of the epoxy compound contains one reversible borate moiety or derivative thereof per molecule.

In one embodiment, the epoxy compound containing one reversible borate moiety or derivative thereof per molecule contains two or more epoxy groups. The epoxy group is selected from ethylene oxide group and oxetane group.

In one embodiment, the epoxy compound containing one reversible borate moiety or derivative thereof per molecule is selected from at least one compound having following structure:

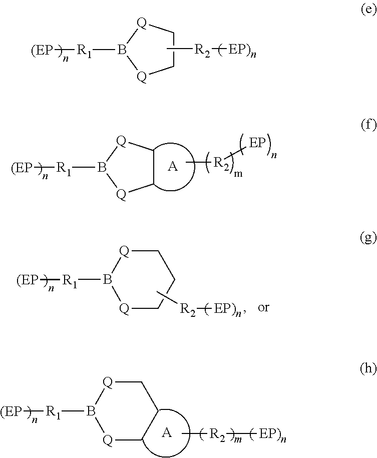

wherein
m is 0 or 1;
each n is independently at least 1;
EP is an ethylene oxide group or oxetane group;
each Q is independently an element of the sixth main group;
each R₁ and R₂ is independently a divalent C₁ to C₂₀ hydrocarbyl; and
wherein A is a ring having 5 to 10 ring members.

In this disclosure, m being 0 means EP is connected with ring (A).

In an embodiment, each n is independently 1, 2 or 3, preferably 1 or 2, more preferably 1.

Each R₁ and R₂ is independently a divalent C₁ to C₂₀ hydrocarbyl.

The terms “hydrocarbyl radical,” “hydrocarbyl” and “hydrocarbyl group” are used interchangeably throughout this document unless otherwise specified. For purposes of this disclosure, a hydrocarbyl radical is defined to be C₁ to C₂₀ radicals, or C₁ to C₁₀ radicals, C₁ to C₆ radicals, or C₅ to C₂₀ radicals, C₆ to C₂₀ radicals, or C₇ to C₂₀ radicals or C₅ to C₁₀ radicals that may be linear, branched, or cyclic where appropriate (aromatic or non-aromatic, such as saturated or unsaturated); and includes hydrocarbyl radicals substituted with other hydrocarbyl radicals and/or one or more functional groups.

Ring (A) is as defined above.

In one embodiment, the epoxy compound containing one reversible borate moiety or derivative thereof per molecule is selected from at least one compound having following structure:

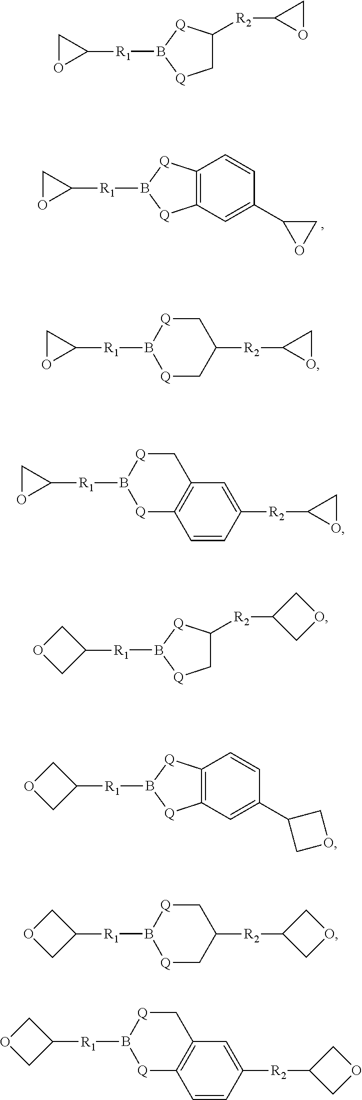

wherein each R₁ and R₂ is as defined above and wherein each Q is independently an element of the sixth main group.

In one embodiment, the reaction system comprises at least one epoxy compound without reversible borate moiety or derivative thereof, which is preferably selected from glycidyl epoxy compound, more preferably polyethylene glycol type, polypropylene glycol type, bisphenol A type, bisphenol F type, bisphenol S type, hydrogenated bisphenol A type epoxy compound.

According to the present invention, it is preferable that epoxy compounds or mixtures there-of used are liquid at room temperature, in particular with a viscosity in the range from 8000 to 12 000 Pa·s. The epoxy equivalent weight (EEW) gives the average mass of the epoxy compound in g per mole of epoxy group. It is preferable that the epoxy compound of the invention have an EEW in the range from about 100 to about 300, in particular from about 150 to about 200.

In one embodiment, the epoxy compound containing one reversible borate moiety or derivative thereof per molecule is present in an amount of 10 wt % to 100 wt %, for example 20 wt % to 100 wt %, 30 wt % to 100 wt %, 40 wt % to 100 wt %, 10 wt % to 80 wt %, 20 wt % to 80 wt %, 10 wt % to 70 wt %, 10 wt % to 60 wt %, 10 wt % to 50 wt %, preferably 30 wt % to 100 wt % or 30 wt % to 80 wt %, based on the total weight of the epoxy compound.

### Curing Agent

The curing agent crosslinks epoxy compound through reaction of epoxy-reacting group with the epoxy group of the epoxy compound. Common classes of curing agent for epoxy compound include amines, acids, acid anhydrides, phenols, alcohols and thiols.

The epoxy-reacting group (also referred to as “functional group capable of reacting with epoxy group”) comprises carboxyl, amino, sulfhydryl or acid anhydride. In a preferred embodiment, the curing agent comprises at least two, for example two or three epoxy-reacting groups.

The curing agent containing amino (amine curing agent) comprises aliphatic polyamine, alicyclic polyamine or aromatic polyamine or mixture thereof. The curing agent containing sulfhydryl comprises aliphatic or aromatic polysulfhydryl compound or mixture thereof. Acid anhydride as the curing agent comprises aliphatic or aromatic polyacid anhydride or mixture thereof.

Amine curing agents of this kind typically have at least two primary or secondary amino groups, and generally they have 2 to 6, more particularly 2 to 4, primary or secondary amino groups.

Examples of customary amine curing agents are
aliphatic polyamines such as ethylenediamine, 1,2-and 1,3-propanediamine, neopentanediamine, hexamethylenediamine, octamethylenediamine, 1,10-diaminodecane, 1,12-diaminododecane, diethylenetriamine, and the like;
   cycloaliphatic diamines, such as 1,2-diaminocyclohexane, 1,3-bis(aminomethyl)-cyclohexane, 1-methyl-2,4-diaminocyclohexane, 4-(2-aminopropan-2-yl)-1-methylcyclohexane-1-amine, isophoronediamine, 4,4′-diaminodicyclo-hexylmethane, 3,3′-dimethyl-4,4′-diaminodicyclohexylmethane, 4,8-diaminotricyclo[5.2.1.0]decane, norbornanediamine, menthanediamine, menthenediamine, and the like;
   aromatic diamines, such as tolylenediamine, xylylenediamine, especially meta-xylylenediamine, Diethyltoluenediamine, bis(4-aminophenyl)methane (MDA or methylenedianiline), bis(4-aminophenyl)sulfone (also known as DADS, DDS or dapsone), and the like;
   cyclic polyamines, such as piperazine, N-aminoethylpiperazine, and the like;
   polyetheramines, especially difunctional and trifunctional primary polyetheramine based on polyethylene glycol, polypropylene glycol, polybutylene oxide, poly(l,4-butanediol), poly-THF or polypentylene oxide, e.g., 4,7,10-trioxatridecane-1,3-diamine, 4,7,10-trioxatridecane-1,13-diamine, primary polyetheramines based on polypropylene glycol having an average molar mass of 230 such as, for example, polyetheramine D 230 or Jeffamine® D 230, difunctional, primary polyetheramines based on polypropylene glycol having an average molar mass of 400, and mixtures of these amines;
   polyamidoamines (amidopolyamines), which are obtainable by the reaction of polycarboxylic acids, especially dicarboxylic acids, with low molecular mass polyamines; or
   phenalkamines (also phenolalkanamines);
      and also mixtures of the aforesaid amine curing agents.

In one embodiment, at least part of the curing agent contains one reversible borate moiety or derivative thereof per molecule.

In one embodiment, the curing agent containing one reversible borate moiety or derivative thereof per molecule contains two or more (for example two, three, four or more, preferably two or three) functional groups capable of reacting with epoxy group), preferably selected from carboxyl, amino, sulfhydryl or acid anhydride, more preferably amino.

In one embodiment, the curing agent containing one reversible borate moiety or derivative thereof per molecule is selected from at least one compound having following structure:

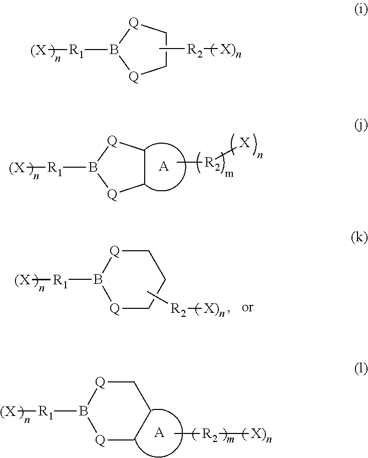

wherein
m is 0 or 1;
each n is independently at least 1;
X is a functional group capable of reacting with epoxy group, preferably carboxyl, amino, sulfhydryl or acid anhydride;
each Q is independently an element of the sixth main group;
each R₁ and R₂ is independently a divalent C₁ to C₂₀ hydrocarbyl; and
A is a ring having 5 to 10 ring members.
   Preferred definition of n, R₁, R₂ and A are as described above. X is preferably amino.

In this disclosure, m being 0 means X is connected with ring (A).

In an embodiment, the curing agent containing one reversible borate moiety or derivative thereof per molecule is selected from at least one compound having following structure:

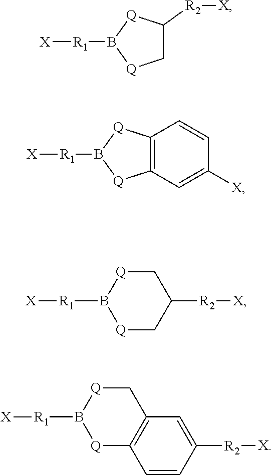

wherein X, R₁ and R₂ are as defined above and wherein each Q is independently an element of the sixth main group.

According to the present invention, the curing agent containing one reversible borate moiety or derivative thereof per molecule can be produced by reacting a compound containing at least one epoxy-reacting group and at least two hydroxyl groups with a compound containing at least one epoxy-reacting group and one B(QH)₂ group or its ester derivative or its anhydride. As mentioned above, each Q is independently an element of the sixth main group, preferably O or S, more preferably O. Preferred epoxy-reacting group is as described above, especially as described for X. Examples of the compound containing at least one epoxy-reacting group and at least two hydroxyl groups comprises primary or secondary aliphatic amines which contain two hydroxyl groups. The specific example includes 1-aminopropane-1,2-diol and N-methyl-or N-ethylaminopropanediol.

In this disclosure, the reaction can be carried out in the absence or presence of a dehydrating agent. The dehydrating agent can be selected from molecular sieves, Na₂SO₄ and MgSO₄. If used, the ratio (g:mol) of the dehydrating agent to the compound containing at least one epoxy-reacting group and at least two hydroxyl groups or to the compound containing at least one epoxy-reacting group and one B(QH)₂ group or its ester derivative or its anhydride can be no more than 800:1, or no more than 500:1, or no more than 200:1, or no more than 100:1, or no more than 50:1, or no more than 20:1, or no more than 10:1, or no more than 5:1, or no more than 1:1, or no more than 1:5.

In an embodiment, the reaction can be carried out in the absence of the dehydrating agent.

In an embodiment, the mole ratio of the compound containing at least one epoxy-reacting group and at least two hydroxyl groups to the compound containing at least one epoxy-reacting group and one B(QH)₂ group or its ester derivative or its anhydride can be in the range from 0.5:1 to 2:1, or from 0.8:1 to 1.2:1, or from 0.9:1 to 1.1:1, for example 1:1.

In an embodiment, the compound containing at least one (for example 1, 2, 3 or 4) epoxy-reacting group and at least two hydroxyl groups is a compound containing at least one (for example 1, 2, 3 or 4) epoxy-reacting group and two hydroxyl groups, preferably is selected from 1,2-diol compound containing the at least one epoxy-reacting group and 1,3-diol compound containing the at least one epoxy-reacting group.

In an embodiment, ester derivative of the compound containing at least one epoxy-reacting group and one B(QH)₂ group means the B(QH)₂ group forms a B(QRₐ)₂ group, wherein each Q is as defined above; each Rₐ is independently hydrocarbyl, preferably alkyl or aryl, more preferably alkyl. The hydrocarbyl can have 1 to 20 carbon atoms, preferably 1 to 10 or 1 to 6 or 1 to 4 carbon atoms. The alkyl can have 1 to 20 carbon atoms, preferably 1 to 10 or 1 to 6 or 1 to 4 (for example 1, 2, 3 or 4) carbon atoms. The aryl can have 6 to 10 carbon atoms, for example can be phenyl.

In an embodiment, the epoxy-reacting group is selected from carboxyl, amino, sulfhydryl or acid anhydride, preferably amino, for example, primary amino group or secondary amino group.

In an embodiment, the reaction is carried out in a solvent in which each reagent can be dissolved, preferably the solvent is selected from C₁-C₆ alcohol (for example methanol, ethanol, isopropanol), THE, dioxane, DMF and mixture thereof, for example a mixture of methanol and THE or a mixture of ethanol and THF. According to method of the present disclosure, the amount of the solvent can be reduced. For example, the ratio (ml:mol) of the solvent to the compound containing at least one epoxy-reacting group and at least two hydroxyl groups or to the compound containing at least one epoxy-reacting group and one B(QH)₂ group or its ester derivative or its anhydride can be less than 1000:1, for example in the range from 900:1 to 150:1 (for example 800:1, 700:1, 600:1, 500:1, 400:1, 300:1, 250:1, 200:1 or 150:1) or from 800:1 to 200:1, or from 800:1 to 250:1.

In an embodiment, the reaction temperature is in the range from 10° C. to the boiling point of the solvent used in the reaction, or from room temperature to the boiling point of the solvent used in the reaction, preferably from room temperature to 100° C. (for example 20° C., 30° C., 40° C., 50° C., 60° C., 65° C., 70° C., 75° C., 80° C., 90° C. or 100° C.), more preferably from 20° C. to 80° C. or from 20° C. to 65° C.

The reaction time can be in the range from 4 minutes to 48 hours (for example 4 minutes, 5 minutes, 10 minutes, 15 minutes, 0.5 hour, 1 hour, 2 hours, 3 hours, 5 hours, 10 hours, 15 hours, 20 hours, 25 hours, 30 hours, 36 hours, 40 hours, 45 hours or 48 hours), preferably from 15 minutes to 36 hours or from 0.5 hour to 24 hours.

The reaction can be carried out under stirring or without stirring.

In this disclosure, the solvent is removed after reaction, preferably the solvent is removed by distillation, for example by spray drying, rotatory evaporator and vacuum dry. In a preferred embodiment, the temperature for removing the solvent (or the distillation temperature) is no more than 80° C. (for example 75° C., 70° C., 65° C., 60° C., 50° C., 40° C., 30° C., or 20° C.) or no more than 60° C., or in the range from 20° C. to 80° C., or in the range from 30° C. to 65° C.

The specific example of compound containing at least one epoxy-reacting group and one B(QH)₂ group includes 3-aminophenylboronic acid or its hydrate or its anhydride.

Regarding the anhydride of compound containing at least one epoxy-reacting group and one B(QH)₂ group, the anhydride can be in the form of trimer, wherein three B(QH)₂ group forms a 6-membered ring, for example forms a trioxatriborinane ring. Taking 3-aminophenylboronic acid as an example, its anhydride can have the following structure:

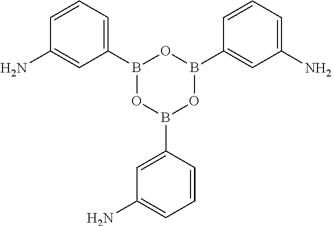 [SMILES: Nc1cccc(B2OB(c3cccc(N)c3)OB(c3cccc(N)c3)O2)c1]

In an embodiment, the reaction for preparing the curing agent containing one reversible borate moiety or derivative thereof per molecule can be carried out at 10° C. to 30° C. for 1 to 48 hours. The reaction can be carried out in a solvent (such as an alcohol). If necessary, a dehydrating agent such as magnesium sulfate can be added.

Taking 1-aminopropane-1,2-diol and 3-aminophenylboronic acid as examples, the curing agent containing one reversible borate moiety or derivative thereof per molecule can be prepared as follows:

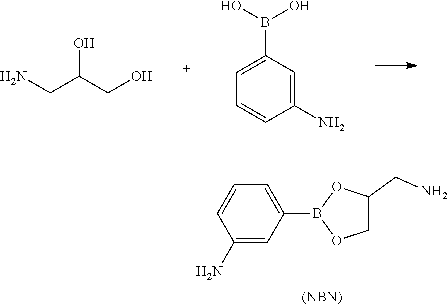

Then, the reaction product (NBN) can be reacted with the epoxy compound to form the reversible epoxy polymer of the present invention.

The curing agent containing one reversible borate moiety or derivative thereof per molecule is present in an amount of 10 wt % to 100 wt %, for example 20 wt % to 100 wt %, 30 wt % to 100 wt %, 40 wt % to 100 wt %, 50 wt % to 100 wt %, 60 wt % to 100 wt %, 10 wt % to 90 wt %, 20 wt % to 80 wt %, preferably 30 wt % to 100 wt % or 30 wt % to 80 wt %, based on the total weight of the curing agent.

### Compound Containing Hydroxyl and Epoxy Group, and BQH-Containing Compound or Its Derivative

In an embodiment, the reaction system further comprises at least one compound containing hydroxyl and epoxy group and at least one BQH-containing compound or its ester derivative, wherein said BQH-containing compound contains two or more B-QH moieties, wherein each Q is independently an element of the sixth main group.

The compound containing hydroxyl and epoxy group usually has one or two carbon atoms between the hydroxyl and the epoxy group, which is preferably glycidol.

The BQH-containing compound or its ester derivative is selected from a compound containing at least two B-Q ester bonds, a compound containing at least one B(QH)₂ group, boric acid, and pyroboric acid, wherein each Q is independently an element of the sixth main group.

A person skilled in the art could understand that two or three B-QH moieties can share one B atom.

The compound containing at least two B-Q ester bonds comprises a compound containing three B-Q ester bonds. The term B-Q ester bond refers to a -B-Q-C- structure. Preferably, the compound containing three B-Q ester bonds has the following structure:

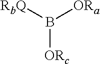

wherein Rₐ, R_{b} and R_{c} are independently hydrocarbyl, preferably alkyl or aryl and wherein each Q is independently an element of the sixth main group.

Preferably, the compound containing three B-Q ester bonds has the following structure:

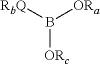

wherein Rₐ, R_{b} and R_{c} are independently hydrocarbyl, preferably alkyl or aryl. Rₐ, R_{b} and R_{c} can be same or different. The hydrocarbyl can have 1 to 20 carbon atoms, preferably 1 to 10 or 1 to 6 or 1 to 4 carbon atoms. The alkyl can have 1 to 20 carbon atoms, preferably 1 to 10 or 1 to 6 or 1 to 4 carbon atoms. The aryl can have 6 to 10 carbon atoms. The typical example of such compound comprises trimethyl borate, triethyl borate, tri-n-propyl borate, tri-isopropyl borate, tri-butyl borate, and tri-tert-butyl borate.

In one embodiment, the compound containing at least one B(QH)₂ group is selected from benzen-1,4-diboronic acid, 3-carboxyphenylboronic acid, aminobenzeneboronic acid, and tetrahydroxydiboron.

In an embodiment, the compound containing hydroxyl and epoxy group and the BQH-containing compound or its ester derivative are used as a reaction product of said two compounds with the curing agent. In this regard, the compound containing hydroxyl and epoxy group can reacted with the curing agent to obtain an intermediate reaction product (reaction product 1), the reaction can be carried out at 35° C. to 70° C. or 40° C. to 60° C. for 0.5 to 5 hours; the intermediate reaction product (reaction product 1) can react with the BQH-containing compound or its ester derivative to obtain the reaction product (reaction product 2), the reaction can be carried out at 50° C. to 90° C. or 60° C. to 80° C. for 0.5 to 5 hours. Taking glycidol, NH₂—R—NH₂ (curing agent) and triethyl borate as example, the reaction scheme can be as follows:

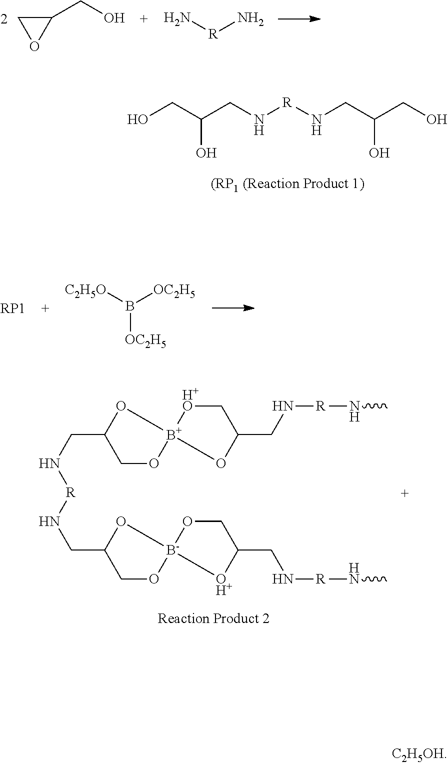

Then, the reaction product (reaction product 2) can react with epoxy compound to obtain the reversible epoxy polymer according to the present invention.

In a preferred embodiment, the compound containing hydroxyl and epoxy group and the BQH-containing compound or its ester derivative are used directly rather than as a reaction product of said two compounds with the curing agent.

### Accelerator

In an embodiment, the reaction system can comprise at least one accelerator. The accelerator can accelerate the curing of the reaction system. Suitable curing accelerators are, for example, tertiary amines, imidazoles, imidazolines, guanidines, urea compounds, and ketimines.

Suitable tertiary amines are, for example, N,N-dimethylbenzylamine, 2,4,6-tris(dimethylaminomethyl)phenol (DMP 30), 1,4-diazabicyclo[2.2.2]octane (DABCO), 1,8-diazabicyclo[5.4.0]undec-7-ene (DBU), S-triazine (Lupragen N 600), bis (2-dimethylaminoethyl) ether (Lupragen N 206), pentamethyldiethylenetri-amine (Lupragen N 301), trimethylaminoethylethanolamine (Lupragen N 400), tetramethyl-1,6-hexanediamine (Lupragen N 500), aminoethylmorpholine, aminopropylmorpholine, aminoethylethyleneurea or N-alkyl-substituted piperidine derivatives.

Suitable imidazoles are imidazole itself and its derivatives such as, for example, 1-methylimidazole, 2-methylimidazole, N-butylimidazole, benzimidazole, N-C₁-C₁₂-alkylimidazoles, N-arylimidazoles, 2,4-ethylmethylimidazole, 2-phenylimidazole, 1-cyanoethylimidazole or N-aminopropyl-imidazole. Suitable imidazolines are imidazoline itself and its derivatives such as, for example, 2-phenylimidazoline.

Suitable guanidines are guanidine itself or its derivatives such as, for example, methylguanidine, dimethylguanidine, trimethylguanidine, tetramethylguanidine (TMG), methyl isobiguanide, dimethyl isobiguanide, tetramethyl isobiguanide, hexamethyl isobiguanide, heptamethyl isobiguanide or dicyandiamine (DICY).

Suitable urea compounds are urea itself and its derivatives such as, for example, 3-(4-chlorophenyl)-1,1-dimethylurea (monuron), 3-phenyl-1,1-dimethylurea (fenuron), 3-(3,4-dichlorophenyl)-1,1-dimethylurea (diuron), 3-(3-chloro-4-methylphenyl)-1,1-dimethylurea (chlorotoluron), and tolyl-2,4-bis-N,N-dimethyl-carbamide (Amicure UR2T).

Suitable ketimines are, for example, Epi-Kure 3502 (a reaction product from ethylenediamine with methyl isobutyl ketone).

### The Reversible Epoxy Polymer and Recycle

In one embodiment, the reversible epoxy polymer according to the present invention can be obtained by the reaction between at least one epoxy compound and at least one curing agent, wherein at least part of the epoxy compound contains one reversible borate moiety or derivative thereof per molecule.

In one embodiment, the reversible epoxy polymer according to the present invention can be obtained by the reaction between at least one epoxy compound and at least one curing agent, wherein at least part of the curing agent contains one reversible borate moiety or derivative thereof per molecule.

In one embodiment, the reversible epoxy polymer according to the present invention can be obtained by the reaction between at least one epoxy compound and at least one curing agent, wherein the reaction system further comprises at least one compound containing hydroxyl and epoxy group and at least one BQH-containing compound or its ester derivative, wherein said BQH-containing compound contains two or more B-QH moieties.

In one embodiment, the reversible epoxy polymer according to the present invention can be obtained by the reaction between at least one epoxy compound and at least one curing agent, wherein at least part of the epoxy compound contains one reversible borate moiety or derivative thereof per molecule and at least part of the curing agent contains one reversible borate moiety or derivative thereof per molecule.

In one embodiment, the reversible epoxy polymer according to the present invention can be obtained by the reaction between at least one epoxy compound and at least one curing agent, wherein at least part of the epoxy compound contains one reversible borate moiety or derivative thereof per molecule, and the reaction system further comprises at least one compound containing hydroxyl and epoxy group and at least one BQH-containing compound or its ester derivative, wherein said BQH-containing compound contains two or more B-QH moieties.

In one embodiment, the reversible epoxy polymer according to the present invention can be obtained by the reaction between at least one epoxy compound and at least one curing agent, wherein at least part of the curing agent contains one reversible borate moiety or derivative thereof per molecule, and the reaction system further comprises at least one compound containing hydroxyl and epoxy group and at least one BQH-containing compound or its ester derivative, wherein said BQH-containing compound contains two or more B-QH moieties.

In one embodiment, the reversible epoxy polymer according to the present invention can be obtained by the reaction between at least one epoxy compound and at least one curing agent, wherein at least part of the epoxy compound contains one reversible borate moiety or derivative thereof per molecule, at least part of the curing agent contains one reversible borate moiety or derivative thereof per molecule, and the reaction system further comprises at least one compound containing hydroxyl and epoxy group and at least one BQH-containing compound or its ester derivative, wherein said BQH-containing compound contains two or more B-QH moieties.

T_{g} of the reversible epoxy polymer can be in the range from −50° C. to 200° C.

The reversible epoxy polymer can also be easily reprocessed via various technical means, such as physical recycle such as hot press, injection molding or chemical recycle.

In an embodiment, the reversible epoxy polymer is reprocessed by chemical recycle. In this regard, the reversible epoxy polymer can be subjected to dissolving in a solvent and then molded by hot press or injection molding after removing the solvent. For this purpose, the solvent can comprise alcohols (such as C₁-C₆ alkanol, especially methanol and ethanol), acid, alkali base, phenols, acetone, N,N-Dimethylmethanamide (DMF) or mixture thereof or its mixture with water, especially mixture of alcohol and water, for example an aqueous solution containing 75 wt % ethanol or a mixture of alcohol and DMF, for example ethanol-DMF solution (volume ratio: 1:1). The reversible epoxy polymer of the present invention can be converted to oligomer by dissolving in solvent, and then the oligomer can be converted to the reversible epoxy polymer for example by removing the solvent, which can be further processed by hot press or injection molding.

In an embodiment, the content of the insoluble substance is less than 10 wt %, preferably less than 5 wt %, more preferably less than 2 wt % or less than 1 wt % or less than 0.5 wt % or less than 0.1 wt % or less than 0.05 wt % after the reversible epoxy polymer of the present invention being subjected to dissolving in solvent, preferably in a mixture of alcohol and water, more preferably in a mixture of ethanol and water, especially in an aqueous solution containing 75 wt % ethanol or a mixture of alcohol and DMF, for example ethanol-DMF solution (volume ratio: 1:1). In a preferred embodiment, there is no insoluble substance after the reversible epoxy polymer of the present invention being subjected to dissolving in the solvent. The content of the insoluble substance is tested as follows: the initial weight of the polymer is weighted (W₀); after dissolving the polymer in the solvent, the insoluble substance is separated by using vacuum filtration and is further vacuum dried and weighted (W₁). The content of the insoluble substance is calculated based on the initial weight of the polymer: W₁/W×100%.

In an embodiment, the reversible epoxy polymer is reprocessed by physical recycle. For example, the reversible epoxy polymer can be pulverized and hot pressed for example at 150° C., 0.5 MPa for 5 minutes.

In an embodiment, the ultimate stress of the reversible epoxy polymer after being reprocessed 3 times at least about 50%, or at least about 55%, or at least about 65%, preferably at least about 70%, more preferably at least about 72% or 73% or 74% of the ultimate stress of the reversible epoxy polymer before reprocessing. For example, the ultimate stress of the reversible epoxy polymer after being reprocessed 3 times can be about 50%, about 55%, about 65%, about 70%, about 75%, about 80%, about 85%, about 90% of the ultimate stress of the reversible epoxy polymer before reprocessing, or can be in the range from about 50% to about 90%, or from about 55% to about 85%, from about 55% to about 80%, from about 55% to about 75%, or from about 60% to about 85%, from about 60% to about 80%, from about 60% to about 75%, or from about 65% to about 85%, from about 65% to about 80%, from about 70% to about 85%, from about 70% to about 80%, from about 72% to about 85%, from about 72% to about 80% of the ultimate stress of the reversible epoxy polymer before reprocessing.

In an embodiment, the Young's modulus of the reversible epoxy polymer after being reprocessed 3 times at least about 50%, or at least about 60%, or at least about 65%, preferably at least about 70%, more preferably at least about 75% of the Young's modulus of the reversible epoxy polymer before reprocessing. For example, the Young's modulus of the reversible epoxy polymer after being reprocessed 3 times can be about 50%, about 60%, about 65%, about 70%, about 75%, about 80%, about 85%, about 90%, about 95%, about 96%, about 97%, about 98% of the Young's modulus of the reversible epoxy polymer before reprocessing, or can be in the range from about 50% to about 98%, or from about 60% to about 98%, from about 70% to about 98%, from about 75% to about 98% of the Young's modulus of the reversible epoxy polymer before reprocessing.

In an embodiment, the ultimate strain of the reversible epoxy polymer after being reprocessed 3 times at least about 50%, or at least about 60%, or at least about 65%, preferably at least about 70%, more preferably at least about 75% or at least about 80% of the ultimate stain of the reversible epoxy polymer before reprocessing. For example, the ultimate strain of the reversible epoxy polymer after being reprocessed 3 times can be about 50%, about 55%, about 60%, about 65%, about 70%, about 75%, about 80%, about 85%, about 90%, or about 95% of the ultimate stain of the reversible epoxy polymer before reprocessing.

In this disclosure, the ultimate stress, ultimate strain and Young's modulus can be characterized as follows: the reversible epoxy polymer was molded by hot press at 150° C., 0.5 MPa for 5 minutes to obtain the testing bar (according to ISO 37:2017, Type 2/Type 3 specimen), the stress-strain curve of the testing bar was characterized by a tensile machine (for example INSTRON 5966 Universal Testing Systems or Zwick/Roell Universal testing machines) at 25° C. under a tensile rate of 5 mm/min. The result is reported as average value of five measurement.

In an embodiment, the reversible epoxy polymer according to the present invention is obtained by the reaction between at least one epoxy compound and at least one curing agent, wherein at least part of the epoxy compound contains one reversible borate moiety or derivative thereof per molecule and/or at least part of the curing agent contains one reversible borate moiety or derivative thereof per molecule. Said reversible epoxy polymer has a water absorption rate and/or the weight loss rate after water soaking of less than 5 wt % or less than 4 wt %, or less than 2 wt %, preferably less than 1.5 wt %, more preferably less than 1 wt % after being socked in water for 24 hours at room temperature. The water absorption rate and the weight loss rate after water soaking are tested as follows: the initial weight of the polymer is recorded as m0, and the weight of the polymer is recorded as m1 after being soaked in water for 24 hours at room temperature; the weight of the polymer is recorded as m2 after being dried in the environment of 120° C. until it reaches the constant weight; the water absorption rate is calculated as: (m1−m0)/m0×100%, and the weight loss rate after water soaking is calculated as: (m0−m2)/m0×100%.

The reversible epoxy polymer of the present invention has thermoplastic property, preferably is able to be processed by pressing, injection molding, extrusion molding, blow molding, calendaring, foaming, solvent plasticizing, mold pressing, casting, reaction molding, for example by granulation and further hot press or extrusion. By “thermoplastic polymer(s)” is meant a polymer that can be melted by heat and then cooled without appreciable change in solid-state properties before and after heating.

### Process for Preparing the Reversible Epoxy Polymer

A further aspect of the present invention is directed to a process for preparing the reversible epoxy polymer of the present invention, which comprises reacting at least one epoxy compound and at least one curing agent, wherein at least part of the epoxy compound contains one reversible borate moiety or derivative thereof per molecule, wherein the derivative of borate moiety represents a moiety with the oxygen in the borate moiety being replaced with other element of the sixth main group; and/or at least part of the curing agent contains one reversible borate moiety or derivative thereof per molecule, wherein the derivative of borate moiety represents a moiety with the oxygen in the borate moiety being replaced with other element of the sixth main group; and/or the reaction system further comprises at least one compound containing hydroxyl and epoxy group and at least one BQH-containing compound or its ester derivative, wherein said BQH-containing compound contains two or more B-QH moieties, and wherein each Q is independently an element of the sixth main group.

As described above, the reaction system can further comprise at least one accelerator.

In the process, the reactant can be mixed for 10 minutes to 24 hours, for example 1 hour to 12 hours to obtain a uniform mixture. The bubbles can be removed during the mixing if necessary. Then, the mixture is reacted at 40° C. to 200° C., for example 50° C. to 150° C. for 10 minutes to 36 hours, for example 1 hour to 30 hours. Then, the mixture can be post-cured at 40° C. to 200° C., for example 50° C. to 150° C. for at least 0.5 hour, and the bubbles can be removed if necessary.

The reversible epoxy polymer of the present invention can be prepared by traditional curing molding process.

### Composite Material, Composition and Use

A further aspect of the present invention is directed to a composite material comprising a substrate and the reversible epoxy polymer according to the present invention. The substrate can comprise carbon fiber and fillers. The substrate can be mixed with the reactant before curing, or mixed with the reversible epoxy polymer, or mixed with the recycled reversible epoxy polymer.

The composite material of the present invention has thermoplastic property. The composite material of the present invention is able to be processed by pressing, injection molding, extrusion molding, blow molding, calendaring, foaming, solvent plasticizing, mold pressing, casting, reaction molding, for example by granulation and further hot press or extrusion.

The composite material of the present invention can be subjected to dissolving in a solvent and then the substrate (such as the fiber and fillers) can be recovered. The suitable solvent is as described above. One aspect of the present invention is directed to a process for recovering substrate, wherein the composite material of the present invention is subjected to dissolving in a solvent and then the substrate is recovered.

A further aspect of the present invention is directed to a composition comprising the reversible epoxy polymer according to the present invention and at least one additive. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates and hydrogenated rosins; UV stabilizers; heat stabilizers; antiblocking agents; release agents; anti-static agents; pigments; colorants; dyes; waxes; silica; fillers; talc; modifier; and the like.

### Blending and Processing of Reversible Epoxy Polymer

The reversible epoxy polymer, composition and composite material described herein may be processed or formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twinscrew extruder, which may include a compounding extruder and a side-arm extruder used directly downstream of a polymerization process. Additionally, additives may be included in the polymer, blend, in one or more components of the blend, and/or in a product formed from the blend, such as a film, as desired. Examples of additives are as described above.

The reversible epoxy polymer can be in any physical form. In one embodiment, reactor granules, defined as the granules of polymer that are isolated from the polymerization reactor prior to any processing procedures, are used. In another embodiment, the polymer is in the form of pellets that are formed from melt extrusion. The polymers can be in above mentioned physical form when used to blend with the additive.

The components of the present invention can be blended by any suitable means, and are typically blended to yield an intimately mixed composition which may be a homogeneous, single phase mixture. For example, they may be blended in a static mixer, batch mixer, extruder, or a combination thereof, that is sufficient to achieve an adequate dispersion of additive in the polymer.

The mixing step may involve first dry blending using, for example, a tumble blender, where the polymer and additive are brought into contact first, without intimate mixing, which may then be followed by melt blending in an extruder. Another method of blending the components is to melt blend the reversible epoxy polymer pellets with the additive directly in an extruder or batch mixer. It may also involve a “master batch” approach, where the final additive concentration is achieved by combining neat polymer with an appropriate amount of additive that had been previously prepared at a higher additive concentration. The mixing step may take place as part of a processing method used to fabricate articles, such as in the extruder on an injection molding machine or blown-film line or fiber line.

In a preferred aspect of the invention, the reversible epoxy polymer and additive are “melt blended” in an apparatus such as an extruder (single or twin screw) or batch mixer. The polymer may also be “dry blended” with the additive using a tumbler, double-cone blender, ribbon blender, or other suitable blender. In yet another embodiment, the polymer and additive are blended by a combination of approaches, for example a tumbler followed by an extruder. A preferred method of blending is to include the final stage of blending as part of an article fabrication step, such as in the extruder used to melt and convey the composition for a molding step like injection molding or blow molding. This could include direct injection of the additive into the extruder, either before or after the polymer is fully melted. Extrusion technology for polymer can reference, for example, PLASTICS EXTRUSION TECHNOLOGY 26-37 (Friedhelm Hensen, ed. Hanser Publishers 1988).

In another aspect of the invention, the composition may be blended in solution by any suitable means, by using a solvent that dissolves components to a significant extent. The blending may occur at any temperature or pressure where the additive and the reversible epoxy polymer remain in solution. As with the solution process the additive is added directly to the finishing train, rather than added to the dry polymer in another blending step altogether.

Thus, in the cases of fabrication of articles using methods that involve an extruder, such as injection molding or blow molding, any means of combining the reversible epoxy polymer and additive to achieve the desired composition serve equally well as fully formulated pre-blended pellets, since the forming process includes a re-melting and mixing of the raw material; example combinations include simple blends of neat polymer pellets and additive, of neat polymer granules and additive, of neat polymer pellets and pre-blended pellets, and neat polymer granules and pre-blended pellets. Here, “pre-blended pellets” means pellets of a composition comprising reversible epoxy polymer and additive at some concentration. In the process of compression molding, however, little mixing of the melt components occurs, and pre-blended pellets would be preferred over simple blends of the constituent pellets (or granules) and additive. Those skilled in the art will be able to determine the appropriate procedure for blending of the polymers to balance the need for intimate mixing of the component ingredients with the desire for process economy.

A further aspect of the present invention is directed to a use of the reversible epoxy polymer and its composites of the present invention in adhesive, coating, paints, flooring, glass replacement, polymer additives, metal substrate, structure material, molding, optical material, encapsulation material, packaging material, sealing materials, medical material, fiber-reinforced material, or as functional material.

The functional material can be used in building and construction, agriculture, automotive, aerospace, energy, wind energy, electrical and electronics, Consumer Goods.

A further aspect of the present invention is directed to a compound having one of following structures:

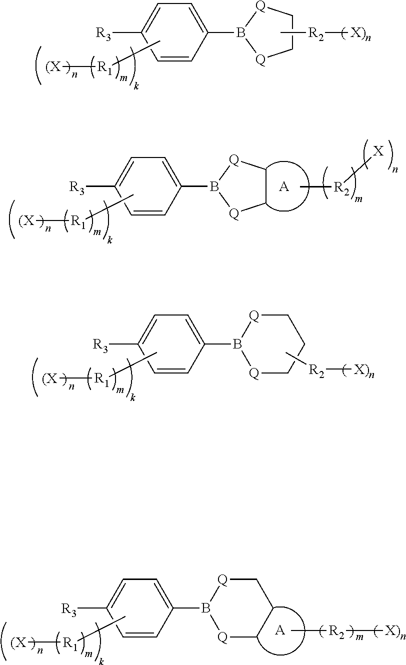

wherein
each m is independently 0 or 1;
k is from 1 to 4;
each n is independently at least 1;
each R₁ is independently a divalent C₁ to C₂₀ hydrocarbyl;
R₂ is a divalent C₁ to C₂₀ hydrocarbyl;
R₃ is H or C₁ to C₂₀ hydrocarbyl;
each Q is independently an element of the sixth main group;
X is a functional group capable of reacting with epoxy group; and
A is a ring having 5 to 10 ring members.

In an embodiment, the variables have following definitions:
each m is independently 0 or 1;
k is 1 or 2;
each n is independently 1, 2 or 3;
each R₁ is independently a divalent C₁ to C₂₀ hydrocarbyl;
R₂ is a divalent C₁ to C₂₀ hydrocarbyl;
R₃ is H or C₁ to C₂₀ hydrocarbyl;
each Q is independently O or S, preferably O;
X is a functional group selected from carboxyl, amino, sulfhydryl or acid anhydride; and
A is a ring having 5 or 6 ring members.

In an embodiment, the compound has one of following structures:

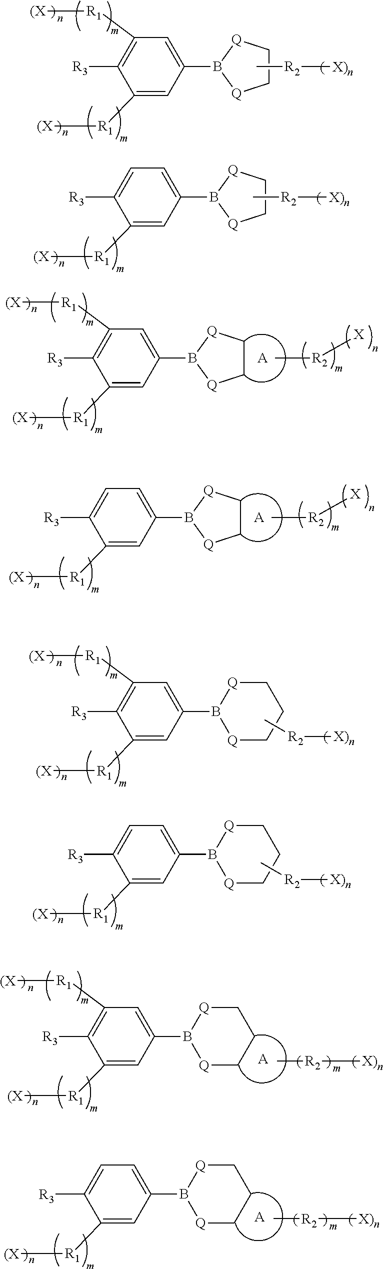

wherein m, n, R₁, R₂, R₃, Q, X and A are as defined above.

According to the present invention, the compound in this aspect can be used to prepare the reversible epoxy polymer according to the present invention.

### EXAMPLES

The ultimate stress, ultimate strain and Young's modulus was characterized as follows: the reversible epoxy polymer was molded by hot press at 150° C., 0.5 MPa for 5 minutes to obtain the testing bar (according to ISO 37:2017, Type 2/Type 3 specimen), the stress-strain curve of the testing bar was characterized by a tensile machine (for example INSTRON 5966 Universal Testing Systems or Zwick/Roell Universal testing machines) at 25° C. under a tensile rate of 5 mm/min. The result is reported as average value of five measurement.

### Example 1

Bisphenol A Epoxy E-44 resin (10.0 g), glycidol (7.6 g), trimethyl borate (5.4 g), polyetheramine (D230, 9.3 g), and 0.093 g N,N-Dimethylbenzylamine (1 wt %, based on polyetheramine D230) were stirred at 20° C. for 4 hours. The bubbles were removed. Then, the mixture was transferred into an open container, and placed in oven at 70° C. and cured for 12 hours. The resulted material was crushed and placed in a 70° C. vacuum oven to further remove the residual small molecules so as to obtain the reversible epoxy polymer.

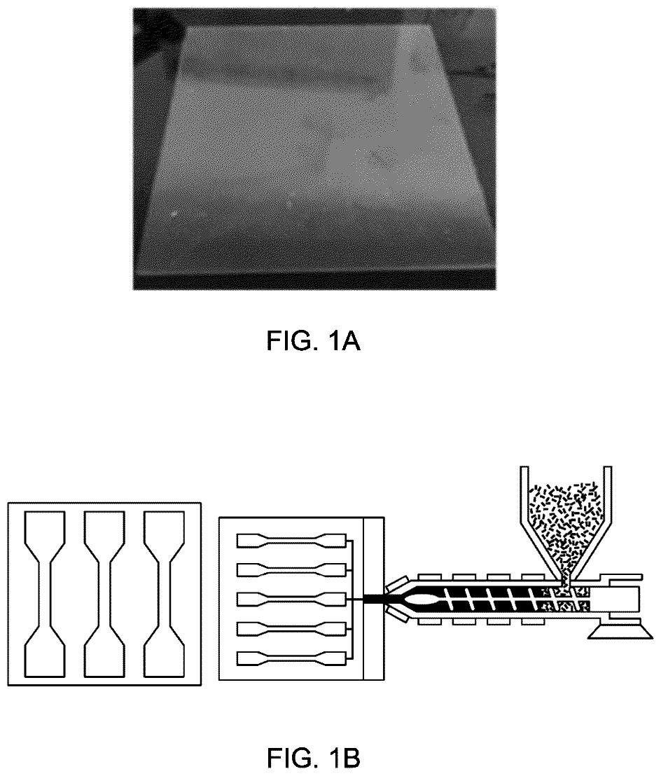

The obtained reversible epoxy polymer can be processed in various ways. The polymer can be molded by hot press at 150° C., 0.5 MPa for 5 minutes or can be injection molded by 150° C., 20 r/min condition as shown in FIG. 1.

To test the mechanical property, the reversible epoxy polymer was molded by hot press at 150° C., 0.5 MPa for 5 minutes to obtain the testing bar (ISO 37:2017 type 2 specimen). The stress-strain curve of the epoxy samples was characterized by a tensile machine (Zwick/Roell Universal testing machines) at 25° C. under a tensile rate of 5 mm/min. The ultimate stress of the reversible epoxy polymer was 28.72 MPa, strain at break was 1.85%, Young's Modulus was 1.64 GPa.

### Example 2

In this example, recycle property of the reversible epoxy polymer was evaluated. The reversible epoxy polymer prepared according to the procedure in example 1 was named as R0, then R0 was pulverized to obtain a powdered granular material. The powdered granular material was further molded by hot press at 150° C., 0.5 MPa for 5 minutes to obtain R1. Then, R2 was prepared from R1 and R3 was prepared from R2, in a similar way. The mechanical properties of R0 to R3 were tested according to the procedure described in example 1 and were summarized in table 1.

TABLE 1
Mechanical properties of original (R0) and
the recycled epoxy polymer (R1 to R3)

| | | | | Ultimate | Young's |
|---|---|---|---|---|---|
| | Ultimate | Ultimate | Young's | Stress | Modulus |
| | Stress | Strain | Modulus | retention | retention |
| Sample | (MPa) | (%) | (GPa) | rate (%) | rate (%) |
| R0 | 25.34 | 1.50 | 1.70 | — | — |
| R1 | 22.26 | 1.54 | 1.54 | 88.1 | 90.6 |
| R2 | 19.96 | 1.41 | 1.49 | 79.1 | 87.6 |
| R3 | 19.65 | 1.55 | 1.32 | 77.9 | 77.6 |

### Example 3 (Comparative)

Reference epoxy polymer was prepared by mixing Bisphenol A Epoxy E-44 (10.0 g), polyetheramine (D230, 2.53 g), and 0.025 g N,N-Dimethylbenzylamine at 100° C. for 3 hours and post curing at 140° C. for 1 hour. The mechanical properties were tested according to the procedure described in example 1. The ultimate stress of the resulted epoxy polymer was 38.64 MPa, strain at break was 2.44%, Young's Modulus was 1.58 GPa. The resulted epoxy polymer could not be reprocessed by hot press.

### Example 4

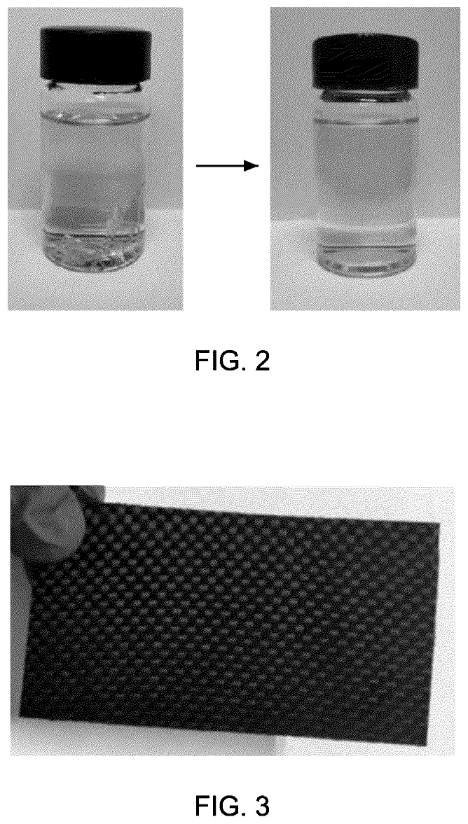

The reversible epoxy polymer was prepared according to the procedure in example 1. The resulted reversible epoxy polymer (0.5 g) was put in 75 wt % ethanol solution (10 ml) at 70° C. for 5 hours, a transparent homogeneous solution was obtained, as shown in FIG. 2. No undissolved solid was collected after vacuum filtration.

The solvent of the solution was evaporated at 70° C. for 10 hours and at 70° C. vacuum for 5 hours to obtain the chemical recycled epoxy polymer. The recycled epoxy polymer was molded by hot press at 150° C., 0.5 MPa for 5 minutes to obtain the testing bar (ISO 37:2017 type 2 specimen). The mechanical properties of the original epoxy polymer and recycled epoxy polymer were tested according to the procedure described in example 1 and were shown in Table 2.

TABLE 2
Mechanical properties of the original and recycled epoxy polymer

| | | | | Young's |
|---|---|---|---|---|
| | Ultimate | Ultimate | Young's | Modulus |
| | Stress | Strain | Modulus | retention |
| Sample | (MPa) | (%) | (GPa) | rate (%) |
| Original | 30.21 | 2.19 | 1.68 | — |
| Chemical recycled | 26.39 | 1.89 | 1.51 | 89.9 |

### Example 5

Bisphenol A Epoxy E-44 resin (10 g), glycidol (7.6 g), trimethyl borate (5.4 g), polyetheramine (D230, 9.3 g), 0.093 g N,N-Dimethylbenzylamine (1 wt %, based on polyetheramine D230) were stirred at 20° C. for 1 hour. The bubbles were removed to obtain pre-polymerized epoxy polymer.

The pre-polymerized epoxy polymer was coated to carbon fiber (CF) fabric, cured at room temperature for 4 hours and then further cured at 70° C. for 12 hours, then was placed in a 70° C. vacuum oven to further remove the residual small molecules to obtain the prepreg composite material (200 mm×10 mm×0.3 mm), as shown in FIG. 3. The reversible epoxy polymer accounts for 30 wt % of the composite material.

Five layers of prepreg composite material were hot-pressed together at 150° C., 0.5 MPa for 5 minutes to obtain the thicker CF composite materials (200 mm×10 mm×1.3 mm). Testing bars (50 mm×10 mm×1.3 mm) were cut from the hot-pressed composite. The mechanical properties were tested according to the procedure described in example 1. The ultimate stress of the CF composite material was 782.6 MPa, strain at break was 3.54%, Young's Modulus was 22.91 GPa.

### Example 6

Bisphenol A Epoxy E-44 (6.16 g), polyetheramine (D230, 4.66 g), glycidol (4 g) and triethyl borate (TEB, 3.94 g) were stirred at 20° C. for 4 hours. The bubbles were removed. Then, the mixture was transferred into an open container and placed in oven at 70° C. and cured for 24 hours. The resulted material was crushed and placed in a 70° C. vacuum oven to further remove the residual small molecules so as to obtain the reversible epoxy polymer. The mechanical properties were tested according to the procedure described in example 1 with Zwick/Roell Universal testing machines being replaced with INSTRON 5966 Universal Testing Systems, testing bar ISO 37:2017 type 3 specimen. The ultimate stress of the reversible epoxy polymer was 27.75 MPa, strain at break was 1.07%, Young's Modulus was 2.90 GPa.

To compare with the traditional thermoset epoxy polymer. The comparative sample of thermoset epoxy polymer was prepared by following process: Bisphenol A Epoxy E-44 (14.97 g) and polyetheramine (D230, 3.79 g) were mixed well at room temperature, transferred to the mold and post cured at 150° C. for 3 hours to obtain the thermoset epoxy polymer.

### DMA Testing

Dynamical mechanical analysis (DMA) was used to analysis the rheology behavior of the polymer to indicate the processability. Storage modulus (G′), loss modulus (G″) and tan delta were measured using an ARES-G2 rheometer (TA Instruments) with 8 mm parallel plates geometry, performed in temperature ramp of 150° C. to 70° C. with cooling rate 10° C./min, strain amplitude controlled in linear region, and frequency at 1 Hz.

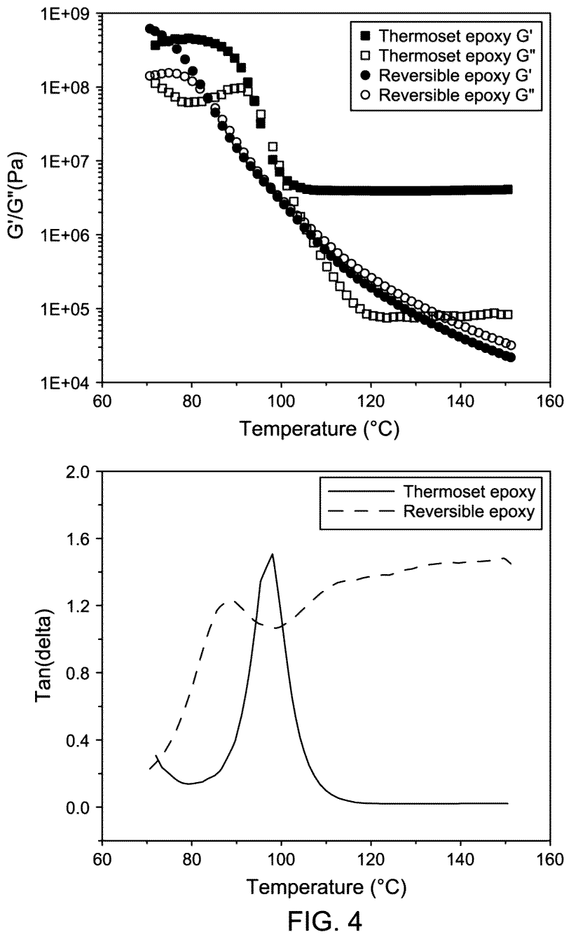

The curves of storage/loss modulus (G′/G″) vs T and tan delta vs T were shown in FIG. 4. From DMA curve, it can be seen after glass transition state, for thermoset epoxy polymer, the material goes into the rubbery stage and value of storage modulus are continually above the value of loss modulus. Even with increasing temperature, the material can't go into the visco-elastic region, meaning the network structure are constantly fixed, the material can't have macro-flow and can't be processed. However, for reversible epoxy polymer of example 6, after glass transition, the material goes into the visco-elastic region, G′ and G″ sharply drop to relatively low values. At 140° C., the G′ and G″ are both in the range of 1E+04 to 1E+05 Pa, indicating good processability at such low viscosity. Also, from tan delta curve, even after glass transition, the tan delta value of reversible epoxy polymer is still around 1, indicating the association interactions in the system, which is the boronic ester exchange.

### TGA Testing

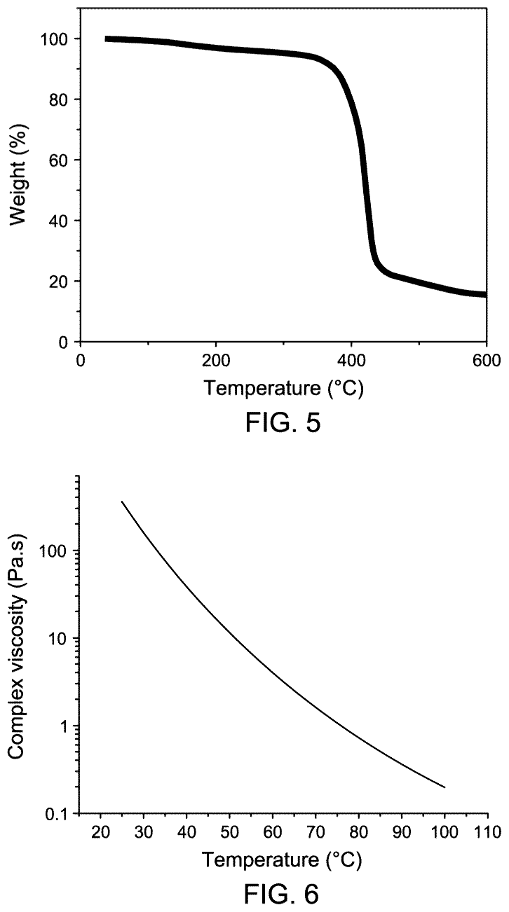

TGA was performed on a Pyris 1 Thermogravimetric Analyzer from PerkinElmer under nitrogen flow. The sample was kept at 50° C. for 5 minutes, then heated from 50.00° C. to 600.00° C. at 10.00° C./min. As shown in FIG. 5, the reversible epoxy polymer from example 6 is stable up to 350° C.

### Example 7

First, polyetheramine (D230, 4.66 g) and glycidol (4 g) were mixed together at 50° C. for 1 hour to obtain the reaction product 1 (RP1).

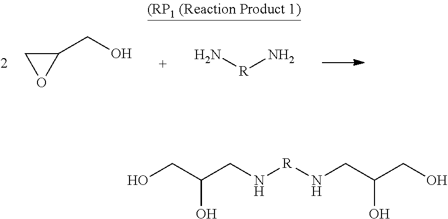

RP1 was a viscous liquid. Viscosity-T curve of RP1 was also measured by Dynamical mechanical analysis (DMA) using an ARES-G2 rheometer (TA Instruments) with 8 mm parallel plates geometry, performed in temperature ramp of 25° C. to 100° C. with heating rate 3° C./min, strain amplitude controlled in linear region, and frequency at 1 Hz. The viscosity-T curve of RP1 was shown in FIG. 6.

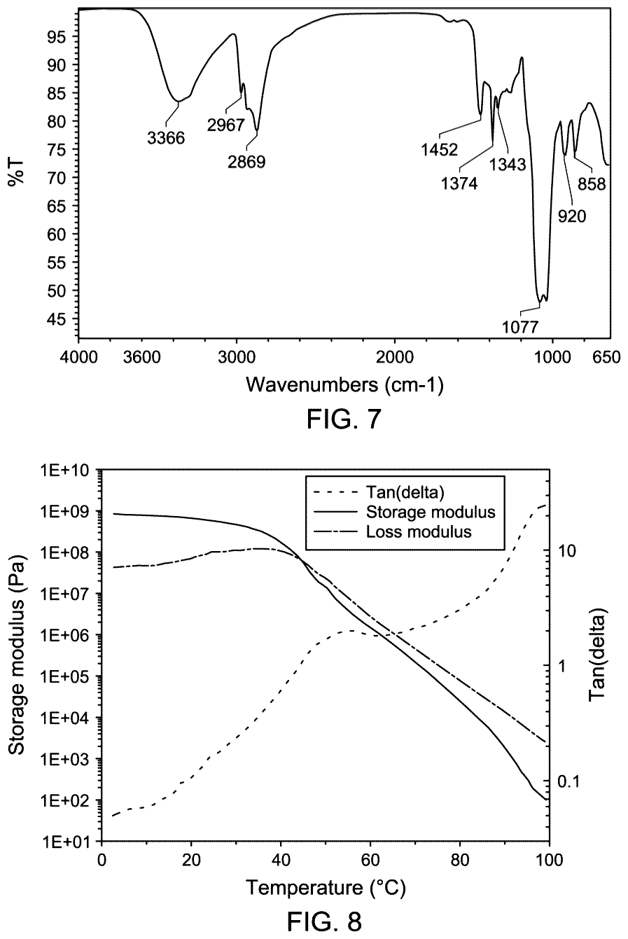

IR spectrum of RP1 was recorded by attenuated total reflectance (ATR) method on Spectrum 100 from PerkingElmer. The scanning range of infrared spectroscopy was 650-4000 cm⁻¹. The corresponding FTIR spectrum of RP1 was showing in FIG. 7. The disappearance of peak around 751 cm⁻¹ (corresponding to C—O—C vibration in epoxy group) proved the fully reaction.

Second, RP1 and triethyl borate (TEB, 3.94 g) were mixed at 70° C. for 1 hour to obtain the reaction product 2 (RP2).

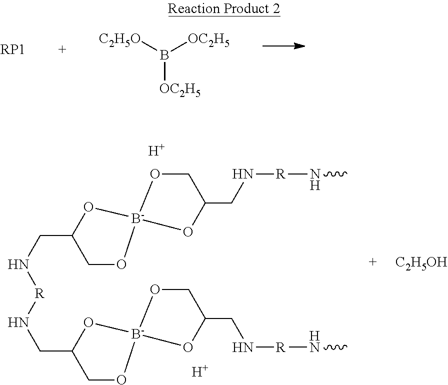

Dynamical mechanical analysis (DMA) of RP2 was measured using an ARES-G2 rheometer (TA Instruments) with 8 mm parallel plates geometry, performed in temperature ramp of 0° C. to 100° C. with heating rate 6° C./min, strain amplitude controlled in linear region, and frequency at 1 Hz. The reaction product 2 was solid state under room temperature, the glass transition temperature was around 50° C. as shown in FIG. 8.

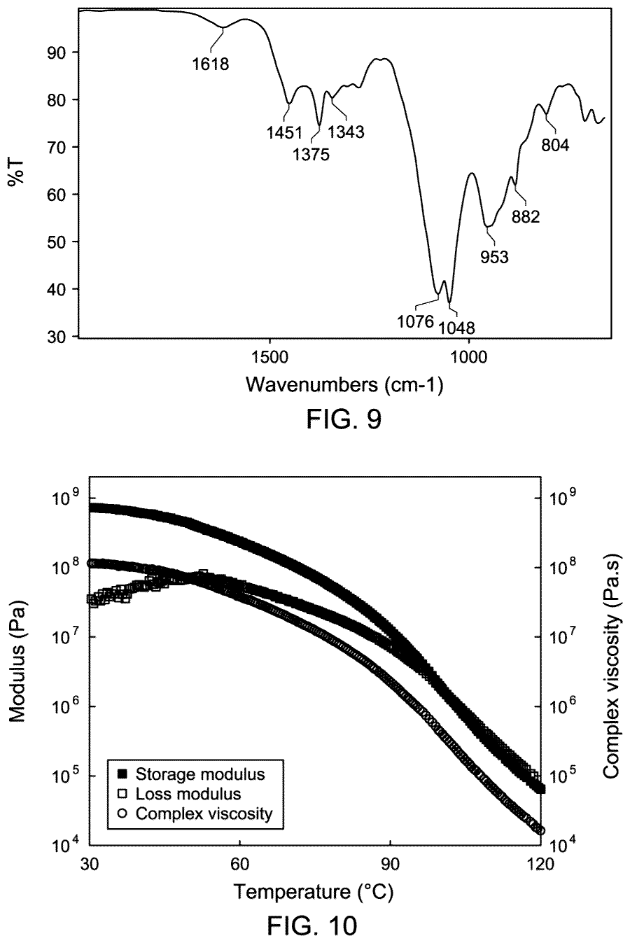

IR spectrum of RP2 was recorded by attenuated total reflectance (ATR) method on Spectrum 100 from PerkingElmer. The scanning range of infrared spectroscopy was 650-2000 cm⁻¹. As shown in FIG. 9, the peak around 953 cm⁻¹ in FTIR spectrum, indicated the formation of BO₄ linkage structure.

Third, Bisphenol A Epoxy E-44 (6.16 g) was added into RP2, and mixed well at 70° C. Then, the mixture was transferred into an open container, placed in oven at 70° C. and cured for 24 hours. The resulted material was crushed and placed in a 70° C. vacuum oven to further remove the residual small molecules so as to obtain the reversible epoxy polymer.

The mechanical properties were tested according to the procedure described in example 6. The ultimate stress of the reversible epoxy polymer was 30.45 MPa, strain at break was 1.17%, Young's Modulus was 3.10 GPa.

### Example 8

Bisphenol A Epoxy E-42 resin (10 g), glycidol (8.7 g), trimethyl borate (6.1 g), polyetheramine (D230, 7.25 g), 0.07 g N,N-Dimethylbenzylamine (1 wt %, based on D230) were stirred at 20° C. for 3 hours. Bubbles were removed to obtain pre-polymerized epoxy resin. Then the mixture was transferred into an open container, placed in oven at 70° C. and cured for 12 hours. The resulted material was crushed and placed in a 70° C. vacuum oven to further remove the residual small molecules so as to obtain the reversible epoxy polymer. The reversible epoxy polymer was molded by hot press at 150° C., 0.5 MPa for 5 minutes.

Dynamical mechanical analysis (DMA) was used to analysis the rheology behavior of the reversible epoxy polymer to indicate the processability. Storage modulus (G′), loss modulus (G″) and tan delta were measured using an ARES-G2 rheometer (TA Instruments) with 8 mm parallel plates geometry, performed in temperature ramp of 120° C. to 30° C. with cooling rate 10° C./min, strain amplitude controlled in linear region, and frequency at 1 Hz.

The DMA curve of the reversible epoxy polymer of example 8 was shown in FIG. 10. The material quickly goes to the visco-elastic region (the value of loss modulus is above the value of storage modulus) at high temperature. Also, the viscosity is very low at high temperature, indicating good processability.

### Example 9 (Comparative)

Bisphenol A Epoxy E-44 resin (10.0 g), glycidol (7.6 g), polyetheramine (D230, 9.3 g), and 0.093 g N,N-Dimethylbenzylamine (curing accelerator) were stirred at 20° C. for 4 hours. Bubbles were removed. Then, the mixture was transferred into an open container, placed in oven at 70° C. and cured for 12 hours. The polymer was very brittle and could not be tested for mechanical properties.

### Example 10

This example demonstrates the self-healing property of the reversible epoxy polymer.

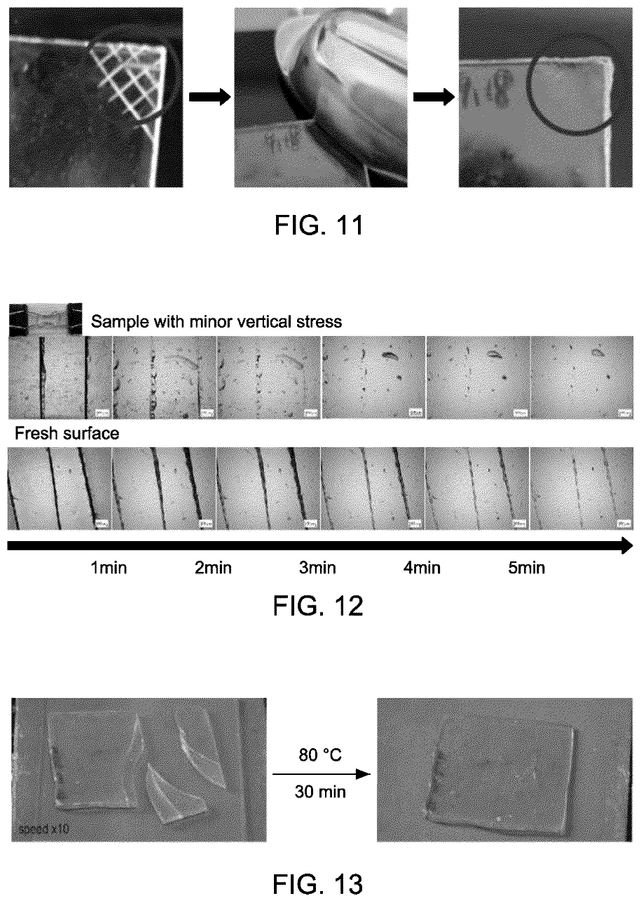

Knives were used to make scratch on the flat surface of reversible epoxy polymer of example 1. The scratch surface disappeared by local pressing at 100° C. for 30 seconds using an iron gun as shown in FIG. 11.

Also, the scratch was observed by Zeiss optical microscopy (Axio Imager.Z2m) under brightfield with reflected light. Meanwhile a hot dryer was used to heat the sample directly. As shown in FIG. 12 (the top pictures), a binder clip was used to stabilize the sample in the middle, due to the minor vertical stress, the scratch could completely disappear very soon (3 minutes). As shown in FIG. 12 (the bottom pictures), the fresh surface was directly heated, after 5 minutes, the scratch almost completely disappeared.

Fracture repair experiment was conducted by putting broken pieces together and putting them in oven at 80° C. for 30 minutes. As shown in FIG. 13, the fractured sample could be recovered to original shape and the interface of the broken areas almost disappeared completely.

### Example 11

1^{st} step: synthesis of curing agent NBN contains one reversible borate moiety:

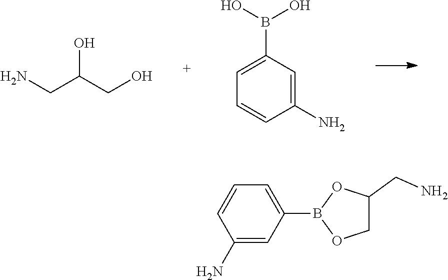 [SMILES: NCC(O)CO ; Nc1cccc(B(O)O)c1 ; NCC1COB(c2cccc(N)c2)O1]

3-amino-1,2-propanediol (9.1 g), 3-aminobenzeneboronic acid (13.6 g), methanol (100 ml), and magnesium sulfate (10.0 g, serving as dehydrating agent) were stirred at 20° C. for 24 hours. A yellow solution was obtained by removing the magnesium sulfate solids via filtration. The methanol solvent was removed by rotary evaporation at 60° C. to obtain a yellow powder product. The powder (NBN) was ground and vacuum dried at 70° C. to a constant weight (21.5 g).

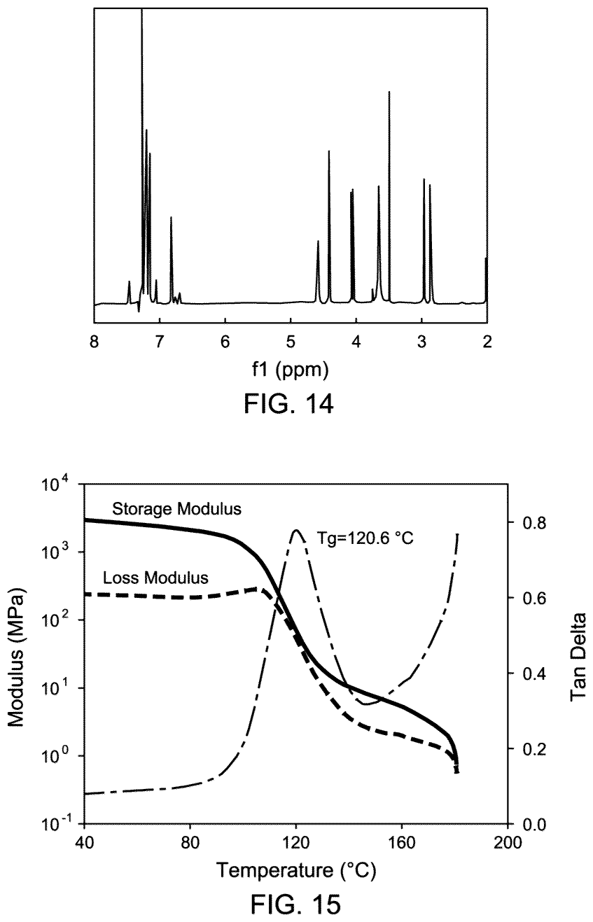

NBN was characterized by 500 MHz Bruker Avance III with CDCl3 as the solvent. The results were shown in FIG. 14. 1H-NMR (500 MHZ, CDCl3) δ6.80-7.26 (4H, Benzene); 4.39-4.61 (2H, OCH2); 4.06 (H, OCH); 2.83-3.00 (2H, CH2). There was a little impurity peak at the position 3.5-3.6 from a small amount of methanol solvent.

2^{nd} step: synthesis of the reversible epoxy polymer. NBN (2.85 g, 0.015 mol), methanol (3 g), hexylamine (1.01, 0.01 mol), 2,2-Bis (4-glycidyloxyphenyl) propane (13.6 g, 0.04 mol, containing 0.08 mol epoxy group) were stirred at room temperature for 1 hour. The precursors were poured into an aluminum plate at 100° C. for 5 hours. Then the materials were crushed by a crusher, and the crushed materials were put in a vacuum at 70° C. for 12 hours to remove methanol solvent. Finally, the powders were molded by hot-pressing under 0.5 MPa at 200° C. for 10 minutes.

### Water Stability Test

About 0.5 g of the molded reversible epoxy polymer material was soaked in water, and the water absorption rate of the material was recorded at different temperatures. The initial weight of the material was recorded as m0, and the weight of the material was recorded as m1 after being soaked in water for a certain period of time. The weight of the material was recorded as m2 after being dried in the environment of 120° C. for aobut 5 hours until it reaches the constant weight. The water absorption rate was calculated as: (m1−m0)/m0×100%, and the weight loss rate after water soaking was calculated as: (m0−m2)/m0×100%.

The water absorption rate of the reversible epoxy polymer was 0.4% at room temperature for 10 hours and 0.9% for 24 hours, suggesting that the reversible epoxy polymer was basically non-water absorbing. At 65° C., the water absorption rate was 4.4% for 10 hours and 7.4% for 24 hours, which also indicated that the temperature had a certain influence on the hydrolysis of borate ester bond. When the reversible epoxy polymer soaked at room temperature for 24 hours or at 65° C. for 24 hours were dried at 120° C. for about 5 hours until it reaches the constant weight, the weight loss rate after water soaking were 0.4% and 0.7%, respectively. Considering the test deviation, there was basically no mass loss.

The reversible epoxy polymer was soaked in water at room temperature for 20 days and the appearance of the polymer remained the same after soaking.

To test the mechanical property, the reversible epoxy polymer was molded by hot press at 200° C., 0.5 MPa for 10 minutes to obtain the testing bar (ISO 37:2017 type 2 specimen). The stress-strain curve of the epoxy samples was characterized by INSTRON 5966 Universal Testing Systems at 25° C. under a tensile rate of 5 mm/min. The mechanical properties of the reversible epoxy polymer of example 11 were as follows: Young's modulus was 1.23 GPa, the ultimate stress was 43.54 MPa, and the strain at break was 4.57%. Moreover, after being soaked at room temperature for 24 hours, the mechanical properties of the reversible epoxy polymer basically did not change: Young's modulus was 1.24 GPa, the ultimate stress was 40.13 MPa, and the strain at break was 4.41%.

### DMA

DMA (Differential Mechanical Analysis) of the reversible epoxy polymer of example 11 was tested with tension fixture on DMA TA Q800. The material was cut into a 3 mm×15 mm×0.6 mm spline, with the temperature ramp from 40° C. to 170° C. at a heating rate of 5° C./min, a frequency at 1 Hz, and strain controlled in linear range. The DMA curves were shown in FIG. 15.

### DSC

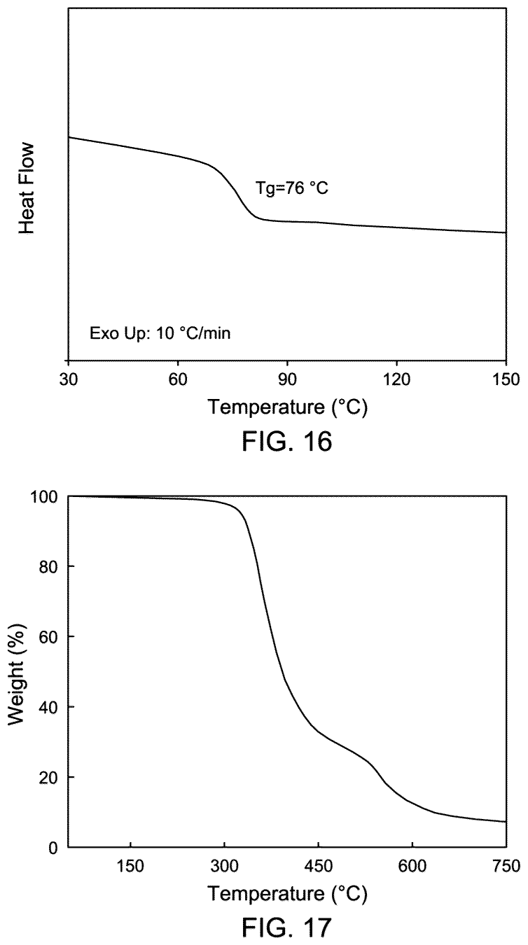

DSC Q200 was used to test the glass transition temperature (T_{g}) of the reversible epoxy polymer of example 11 at a heating rate of 10° C./min and the DSC curve was shown in FIG. 16, wherein T_{g} is 76° C.

### TGA

TGA Q500 thermogravimetric analyzer was used to test the mass change of the reversible epoxy polymer of example 11 between 50° C. and 800° C. at a heating rate of 10° C./min under air flow. The TGA curve was shown in FIG. 17, wherein Td5 was 325° C.

### Example 12

In 1^{st} step, NBN curing agent was prepared following same procedure with that in example 11.

In 2^{nd} step, NBN (0.95 g, 0.005 mol), methanol (1.0 g), 2,2-Bis(4-glycidyloxyphenyl)propane (6.8 g, 0.02 mol, containing 0.04 mol epoxy group) and hexylamine (1.01 g, 0.01 mol) were stirred at room temperature for 1 hour. The precursors were poured into an aluminum plate at 100° C. for 5 hours. Then the materials were crushed by a crusher, and the crushed materials were put in a vacuum at 70° C. for 12 hours. Finally, the powders were put into a hot-pressing mold, and molded under 0.5 MPa at 200° C. for 10 minutes.

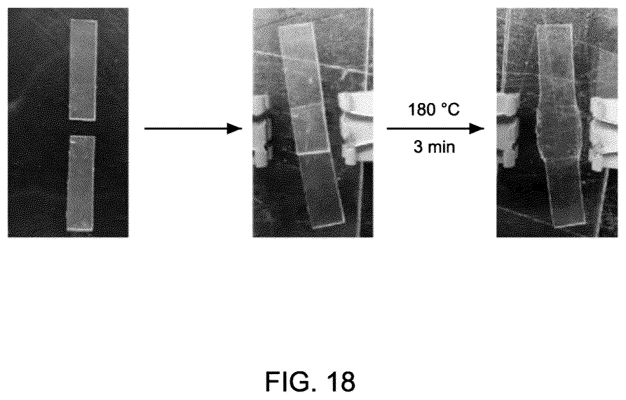

The fracture healing under elevated temperature was also tested. The molded materials were cut into two rectangle samples (20 mm×5 mm×0.5 mm). The two rectangle samples were weld by clamping between two pieces of glass under 180° C. for 3 minutes, as shown in FIG. 18. The samples reached the viscous state. It can be seen from FIG. 18 that the welding interface between the two samples disappeared. The mechanical properties were tested by a tension machine (Zwick/Roell Universal testing machines) at 25° C. under a tensile rate of 5 mm/min.

The mechanical properties of the reversible epoxy polymer were as follows: Young's modulus was 1.64 GPa, the ultimate stress was 56.28 MPa, and the strain at break was 6.00%.

The mechanical properties of the welded sample were as follows: Young's modulus was 1.63 GPa, the ultimate stress was 44.51 MPa, and the strain at break was 3.26%.

As can be seen, the mechanical properties can be healed very well. The Young's modulus of the material can be consistent with the original material. The stress was healed 80%.

### Example 13

In 1^{st} step, NBN curing agent was prepared following same procedure with that in example 11.

In 2^{nd} step, NBN (0.95 g, 0.005 mol), methanol (1 g), hexylamine (3.03, 0.03 mol), 2,2-Bis(4-glycidyloxyphenyl)propane (13.6 g, 0.04 mol, containing 0.08 mol epoxy group) were stirred at room temperature for 1 hour. The precursors were poured into an aluminum plate at 100° C. for 12 hours. Then the materials were crushed by a crusher, and the crushed materials were put in a vacuum at 70° C. for 12 hours to remove methanol solvent. Finally, the powders were molded by hot-pressing under 0.5 MPa at 200° C. for 10 minutes.

The mechanical properties of the reversible epoxy polymer were as follows: Young's modulus was 2.04 GPa, the ultimate stress was 51.28 MPa, and the strain at break was 31.35%.

### Example 14

The reversible epoxy polymers were prepared according to the procedure in example 1 and example 11, respectively. The resulted reversible epoxy polymers (0.5 g) were respectively put in ethanol-DMF solution (volume ratio: 1:1, 10 ml) at 70° C. for 0.5 hour. No undissolved solid was collected after filtration of both solutions.

### Example 15—In Situ Generation of NBN Curing Agent Monitored by NMR Spectroscopy

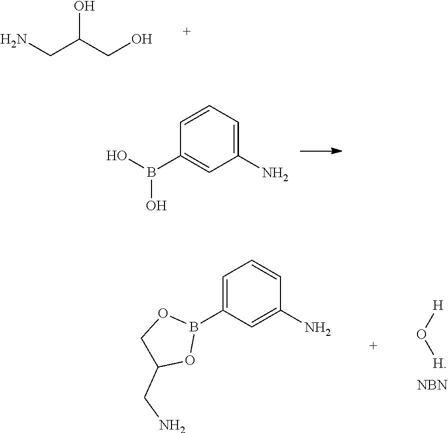

In four vials, solutions were prepared as follows:
Vial 1: 3-amino benzeneboronic acid in 0.50 ml methanol-d4.
Vial 2: NBN in 0.50 ml methanol-d4.
Vial 3: NBN (0.20 mmol, 38 mg) and 3-amino benzeneboronic acid (0.20 mmol, 27 mg) in 0.50 ml methanol-d4
Vial 4: 3-amino benzeneboronic acid (0.20 mmol, 27 mg) and 3-amino-1,2-propanediol (0.20 mmol, 18 mg) in 0.50 ml methanol-d4.

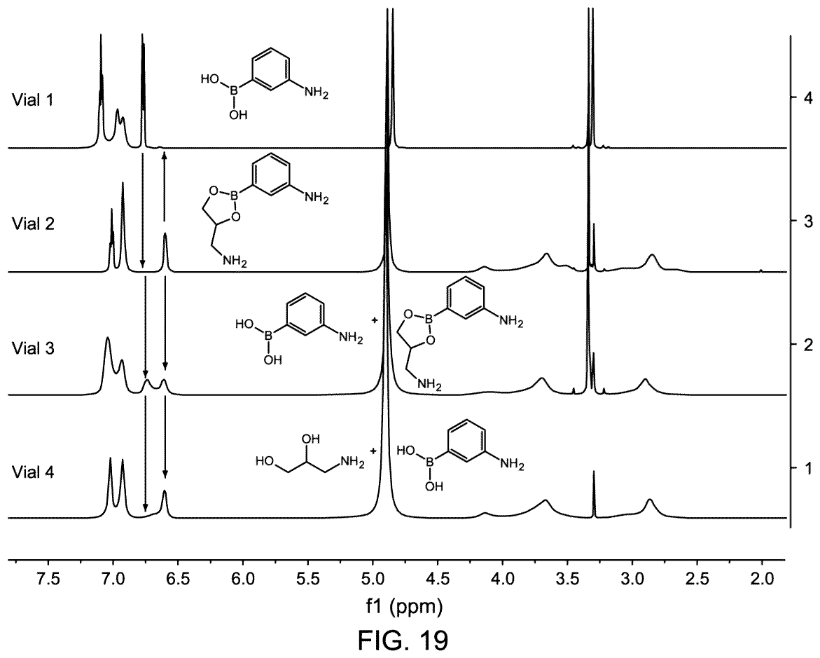

¹H NMR spectra as shown in FIG. 19 were measured on a 600 MHz Avance III NMR. The consumption of 3-amino benzeneboronic acid was monitored by the disappearance of the peak at 6.77 ppm, and the generation of NBN curing agent was monitored by the appearance of the peak at 6.60 ppm. The in situ NMR indicated that the generation of NBN curing agent happened at room temperature without dehydrating agent.

### Example 16—Synthesis of NBN Curing Agent with Dehydrating Agent

3-amino-1,2-propanediol (Diol) (4.6 g, 0.050 mol) and 3-aminobenzeneboronic acid (6.8 g, 0.050 mol) were dissolved in 50 mL methanol with excess amount of molecular sieves (40 g) as dehydrating agent. The mixture was stirred at 25° C. for 21 hours, followed by filtration to remove the dehydrating agent. All volatiles were removed with rotatory evaporator at 45° C., until a white powder was achieved. The resulting product was dried under vacuum for 24 hours and obtained at a yield of 93%.

### Example 17—Synthesis of NBN Curing Agent without Dehydrating Agent

3-amino-1,2-propanediol (Diol) (1.8 g, 0.020 mol) and 3-aminobenzeneboronic acid (BA) (2.7 g, 0.020 mol) was dissolved in a solvent as shown in table 3 until all the solutes were dissolved and a clear solution was achieved. The mixture was stirred at the indicated temperature for indicated time (see table 3). All volatiles were removed with rotatory evaporator at 45° C., yielding the desired product as a white powder. The resulting product was dried under vacuum at 50° C. for 24 hours. The details were shown in table 3.

TABLE 3
Reaction scale and conditions for the synthesis
of NBN curing agent without dehydrating agent.

| | | Reaction | | Reaction | | |
|---|---|---|---|---|---|---|
| Diol | BA | temp. | Solvent | time | | Yield |
| 1.8 g, | 2.7 g, | 60° C. | Ethanol (5 ml) | 22 | hours | 96% |
| 0.020 mol | 0.020 mol | | THF (10 ml) | | | |
| 1.8 g, | 2.7 g, | 50° C. | Methanol | 2.5 | hours | 97% |
| 0.020 mol | 0.020 mol | | (15 ml) | | | |
| 1.8 g, | 2.7 g, | Room temp. | Methanol | 2.5 | hours | 97% |
| 0.020 mol | 0.020 mol | | (15 ml) | | | |

### Example 18—Using 3-Aminobenzeneboronic Acid Monohydrate from Different Sources

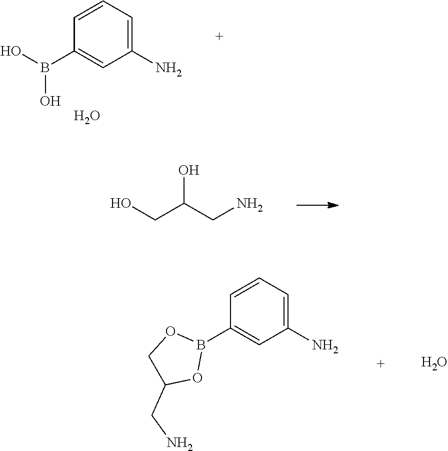

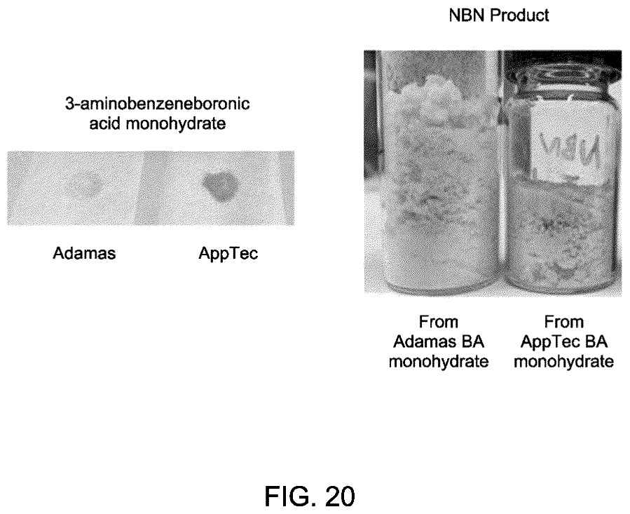

3-aminobenzeneboronic acid monohydrate from Adamas Reagent Co., Ltd or Wuxi AppTec Co., Ltd was used to illustrate the synthesis of NBN. 3-aminobenzeneboronic acid monohydrate (15.5 g, 0.10 mol) and 3-amino-1,2-propanediol (9.1 g, 0.10 mol) were mixed in flask respectively. Methanol (30 ml) was added to dissolve the mixture. The mixture was stirred at room temperature for 5 minutes. The reaction mixture was dried under vacuum until a white powder was achieved. The resulting white powder was dried with vacuum oven at 70° C. for 24 hours, yielding powder NBN, the yield of NBN was similar with those in example 17. The appearance of raw materials from different sources and products thereof were shown in FIG. 20. As can be seen, NBN can be synthesized by using 3-aminobenzeneboronic acid monohydrate from different sources.

### Example 19—Using Anhydride of 3-Aminobenzeneboronic Acid

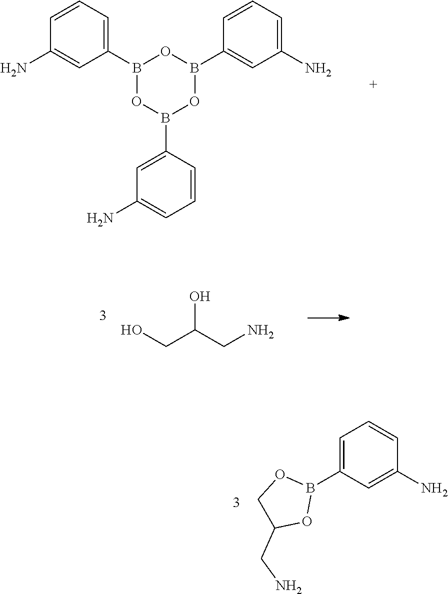 [SMILES: Nc1cccc(B2OB(c3cccc(N)c3)OB(c3cccc(N)c3)O2)c1 ; NCC(O)CO ; NCC1COB(c2cccc(N)c2)O1]

Anhydride of 3-aminobenzeneboronic acid (71 mg, 0.20 mmol) and 3-amino-1,2-propanediol (55 mg, 0.60 mmol) were mixed in flask with 1 ml methanol. The mixture was stirred at room temperature for 5 minutes. The reaction mixture was dried under vacuum until a white powder was achieved and the resulting product was dried with vacuum oven at 70° C. for 24 hours, yielding powder NBN (107 mg, 93%).

### Other Embodiments

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A reversible epoxy polymer obtainable by the reaction between at least one epoxy compound and at least one curing agent, wherein
at least part of the epoxy compound contains one reversible borate moiety or derivative thereof per molecule, wherein the derivative of borate moiety represents a moiety with the oxygen in the borate moiety being replaced with other element of the sixth main group; and/or
at least part of the curing agent contains one reversible borate moiety or derivative thereof per molecule, wherein the derivative of borate moiety represents a moiety with the oxygen in the borate moiety being replaced with other element of the sixth main group; and/or
the reaction system further comprises at least one compound containing hydroxyl and epoxy group and at least one BQH-containing compound or its ester derivative, wherein said BQH-containing compound contains two or more B-QH moieties, wherein each Q is independently an element of the sixth main group.

2. The reversible epoxy polymer according to claim 1, wherein the reversible borate moiety or derivative thereof has a structure of Formula (I): 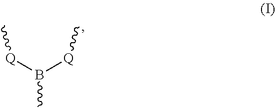
wherein each Q is independently an element of the sixth main group.

3. The reversible epoxy polymer according to claim 2, wherein the -Q-B-Q- moiety in Formula (I) forms a boron-containing ring having 5 to 8 ring members together with 2 to 5 carbon atoms, optionally the boron-containing ring is fused with a further ring to form a fused ring system.

4. The reversible epoxy polymer according to claim 3, wherein the boron-containing ring has the following structure: 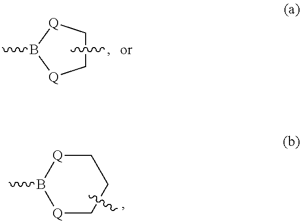
the fused ring system containing the boron-containing ring has the following structure: 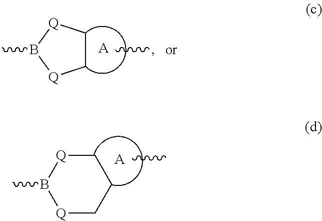
wherein A is a ring having 5 to 10 ring members and wherein each Q is independently an element of the sixth main group.

5. The reversible epoxy polymer according to claim 1, wherein the epoxy compound containing one reversible borate moiety or derivative thereof per molecule contains two or more epoxy groups.

6. The reversible epoxy polymer according to claim 1, wherein the epoxy compound containing one reversible borate moiety or derivative thereof per molecule is selected from at least one compound having following structure: 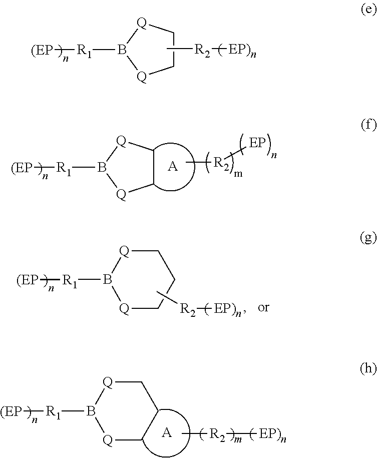
wherein
m is 0 or 1;
each n is independently at least 1;
EP is an ethylene oxide group or oxetane group;
each Q is independently an element of the sixth main group;
each R₁ and R₂ is independently a divalent C₁ to C₂₀ hydrocarbyl; and
wherein A is a ring having 5 to 10 ring members.

7. The reversible epoxy polymer according to claim 1, wherein the curing agent containing one reversible borate moiety or derivative thereof per molecule contains two or more functional groups capable of reacting with epoxy group.

8. The reversible epoxy polymer according to claim 1, wherein the curing agent containing one reversible borate moiety or derivative thereof per molecule is selected from at least one compound having following structure: 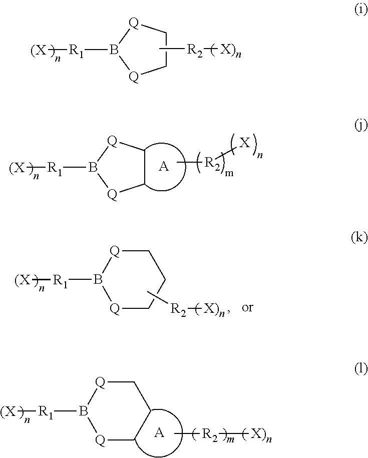
wherein
m is 0 or 1;
each n is independently at least 1;
each R₁ and R₂ is independently a divalent C₁ to C₂₀ hydrocarbyl;
each Q is independently an element of the sixth main group;
X is a functional group capable of reacting with epoxy group; and
A is a ring having 5 to 10 ring members.

9. The reversible epoxy polymer according to claim 1, wherein the epoxy compound containing one reversible borate moiety or derivative thereof per molecule is present in an amount of 10 wt % to 100 wt %.

10. The reversible epoxy polymer according to claim 1, wherein the curing agent containing one reversible borate moiety or derivative thereof per molecule is present in an amount of 10 wt % to 100 wt %.

11. The reversible epoxy polymer according to claim 1, wherein the BQH-containing compound or its ester derivative is selected from a compound containing at least two B-Q ester bonds, a compound containing at least one B(QH)₂ group, boric acid, and pyroboric acid, and wherein each Q is independently an element of the sixth main group.

12. The reversible epoxy polymer according to claim 11, wherein the compound containing at least two B-Q ester bonds comprises a compound containing three B-Q ester bonds.

13. The reversible epoxy polymer according to claim 11, wherein the compound containing at least one B(QH)₂ group is selected from benzen-1,4-diboronic acid, 3-carboxyphenylboronic acid, aminobenzeneboronic acid, and tetrahydroxydiboron.

14. The reversible epoxy polymer according to claim 1, wherein the compound containing hydroxyl and epoxy group has one or two carbon atoms between the hydroxyl and the epoxy group.

15. The reversible epoxy polymer according to claim 1, wherein the ultimate stress of the reversible epoxy polymer after being reprocessed 3 times at least about 50%, or at least about 65%.

16. The reversible epoxy polymer according to claim 1, wherein the Young's modulus of the reversible epoxy polymer after being reprocessed 3 times at least about 50%, or at least about 65%.

17. The reversible epoxy polymer according to claim 1, wherein the reversible epoxy polymer is obtained by the reaction between at least one epoxy compound and at least one curing agent, wherein at least part of the epoxy compound contains one reversible borate moiety or derivative thereof per molecule and/or at least part of the curing agent contains one reversible borate moiety or derivative thereof per molecule, and wherein at least one of the water absorption rate and the weight loss rate after water soaking of the reversible epoxy polymer is less than 5 wt %.

18. The reversible epoxy polymer according to claim 1, wherein the content of the insoluble substance is less than 10 wt %.

19. The reversible epoxy polymer according to claim 1, wherein the derivative of borate moiety represents a moiety with the oxygen in the borate moiety being replaced with S and/or Q is O or S.

20. The reversible epoxy polymer according to claim 1, wherein the reversible epoxy polymer has self-healing property.

21. The reversible epoxy polymer according to claim 1, wherein reversible epoxy polymer has thermoplastic property.

22. (canceled)

23. (canceled)

24. (canceled)

25. (canceled)

26. (canceled)

27. A compound having one of following structures: 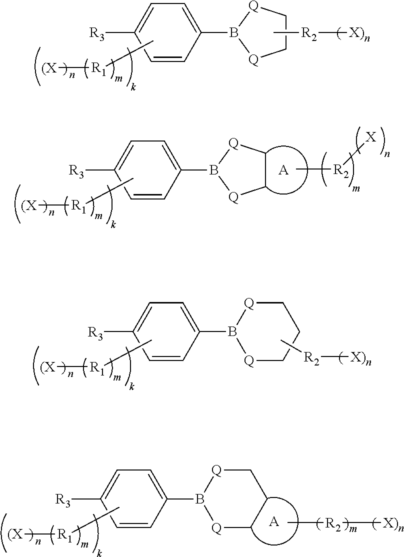
wherein
each m is independently 0 or 1;
k is from 1 to 4;
each n is independently at least 1;
each R₁ is independently a divalent C₁ to C₂₀ hydrocarbyl;
R₂ is a divalent C₁ to C₂₀ hydrocarbyl;
R₃ is H or C₁ to C₂₀ hydrocarbyl;
each Q is independently an element of the sixth main group;
X is a functional group capable of reacting with epoxy group; and
A is a ring having 5 to 10 ring members.

28. The compound according to claim 27, wherein each
m is independently 0 or 1;
k is 1 or 2;
each n is independently 1, 2 or 3;
each R₁ is independently a divalent C₁ to C₂₀ hydrocarbyl;
R₂ is a divalent C₁ to C₂₀ hydrocarbyl;
R₃ is H or C₁ to C₂₀ hydrocarbyl;
each Q is independently O or S;
X is a functional group selected from carboxyl, amino, sulfhydryl or acid anhydride; and
A is a ring having 5 or 6 ring members.

29. The compound according to claim 27, wherein said compound has one of following structures: 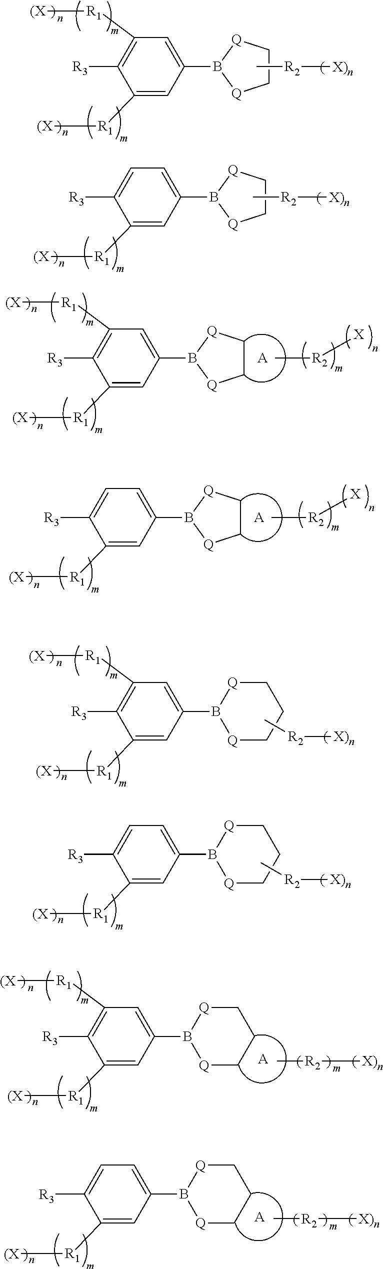
wherein m, n, R₁, R₂, R₃, Q, X and A are as defined in claim 27 or 28.

30. (canceled)

31. (canceled)

32. (canceled)

33. (canceled)

34. (canceled)

35. (canceled)

36. (canceled)

37. (canceled)

38. (canceled)

39. (canceled)
